(19) United States
(12) Patent Application Publication
(10) Pub. No.: US 2013/0142098 A1
(43) Pub. Date: Jun. 6, 2013

(54) APPARATUS AND METHOD FOR TRANSMITTING INFORMATION REGARDING POWER COORDINATION IN MULTI-COMPONENT CARRIER SYSTEM

(71) Applicants: Ki Bum Kwon, Seoul (KR); Myung Cheul Jung, Seoul (KR); Sung Jin Suh, Seoul (KR)

(72) Inventors: Ki Bum Kwon, Seoul (KR); Myung Cheul Jung, Seoul (KR); Sung Jin Suh, Seoul (KR)

(21) Appl. No.: 13/814,554

(22) PCT Filed: Aug. 10, 2011
(86) PCT No.: PCT/KR11/05857

§ 371 Date: Feb. 6, 2013

(30) Foreign Application Priority Data
Aug. 13, 2010 (KR) 10-2010-0077566

(51) Int. Cl. H04W 52/04

(52) U.S. Cl. CPC H04W 52/04
USPC 370/311

(57) ABSTRACT

A method and apparatus for transmitting information regarding power coordination by a mobile station (MS) in a multi-component carrier system are provided. The method includes: generating information regarding power coordination (PC) indicating an amount or a range by which uplink maximum transmission power of the MS is to be adjusted; and transmitting the information regarding PC to a base station (BS). Accordingly, a scheduling error in the BS due to ambiguity of power coordination can be reduced and scheduling can be performed adaptively to maximum transmission power of a provided mobile station (MS) or a component carrier.

### CROSS-REFERENCE TO RELATED APPLICATIONS

This application is the National Stage Entry of International Application No. PCT/KR2011/005857, filed on Aug. 10, 2011 and claims priority from and the benefit of Korean Patent Application No. 10-2010-0077566, filed on Aug. 11, 2010, and Korean Patent Application No. 10-2010-0078379, filed on Aug. 13, 2010, all of which are hereby incorporated by reference for all purposes as if fully set forth herein

### BACKGROUND

1. Field

The present invention relates to wireless communication and, more particularly, is to an apparatus and method for transmitting information regarding power coordination in a multi-component carrier system.

2. Discussion of the Background

A 3GPP (3rd Generation Partnership Project) LTE (Long Term Evolution and an IEEE (Institute of Electrical and Electronics Engineers) 802.16m have been developed as candidates of a next-generation wireless communication system. The 802.16m standard involves two aspects: continuity of the past of correcting the existing 802.16e standard; and continuity of the future as a standard for a next-generation IMT-Advanced system. Thus, the 802.16m standard is required to meet advanced requirements for the IMT-Advanced system while maintaining compatibility with a mobile WiMAX system based on the 802.16e standard.

A wireless communication system generally uses a single bandwidth to transmit data. For example, a 2nd-generation wireless communication system uses a bandwidth of 250 KHz to 1.25 MHz, and a 3rd-generation wireless communication system uses a bandwidth of 5 MHz to 10 MHz. In order to support an increasing transmission capacity, recently, the 3GPP LTE or the 802.16m continues to extend a bandwidth of 20 MHz or larger. Increasing the bandwidth to increase the transmission capacity would be unavoidable, but the support of a large bandwidth may cause much power consumption in case in which the level of a required service is low.

Thus, a multi-carrier system has emerged to define carriers having a single bandwidth and a central frequency and transmit and/or receive data in a wideband through multiple carriers. It supports both a narrowband and a wideband by using one or more carriers. For example, if a single carrier corresponds to a bandwidth of 5 MHz, a bandwidth of a maximum 20 MHz can be supported by using four carriers.

One of methods for effectively utilizing resources of a mobile station (MS) by a base station (BS) is using power information of the MS. A power control technology is an is essential core technology for minimizing an interference element to effectively distribute resources and reducing battery consumption of a MS in wireless communication. The MS may determine uplink transmission power according to scheduling information such as transmission power control (TPC), modulation and coding scheme (MCS), a bandwidth, and the like, allocated by the BS.

As a multi-component carrier system has been introduced, uplink transmission power of component carriers is required to be collectively considered, making it complicated to control power of the MS. Such complexity may cause a problem in the aspect of maximum transmission power of the MS. In general, the MS is to operate with power lower than the maximum transmission power, transmission power within an allowable range.

If the BS performs scheduling requesting transmission power higher than the maximum transmission power, actual uplink transmission power would exceed the maximum transmission power or would be limited to the maximum transmission power determined by hardware capacity of the MS. Thus, the MS cannot transmit a signal with the transmission power requested by the BS, and thus uplink performance is degraded.

This is because power control of multi-component carriers is not clearly defined or because information regarding uplink transmission power is not sufficiently shared by the MS and the base station.

### SUMMARY

An aspect of the present invention provides an apparatus and method for transmitting information regarding power coordination in a multi-component carrier system.

Another aspect of the present invention provides an apparatus and method for receiving information regarding power coordination in a multi-component carrier system.

Another aspect of the present invention provides an apparatus and method for designing power coordination in a multi-component carrier system.

Another aspect of the present invention provides an apparatus and method for checking information regarding power coordination in a multi-component carrier system.

Another aspect of the present invention provides an apparatus and method for configuring information regarding power coordination by considering the number of component carriers of a mobile station (MS) in a multi-component carrier system.

Another aspect of the present invention provides an apparatus and method for configuring information regarding power coordination by considering hardware characteristics of an MS in a multi-component carrier system.

Another aspect of the present invention provides an apparatus and method for generating a MAC PDU including information regarding power coordination in a multi-component carrier system.

Another aspect of the present invention provides an apparatus and method for transmitting information indicating a transmission of information regarding power coordination in a multi-component carrier system.

Another aspect of the present invention provides a method for performing scheduling by using information regarding power coordination in a multi-component carrier system.

According to an aspect of the present invention, there is provided a method for transmitting information regarding power coordination by a mobile station (MS) in a is multi-component carrier system. The method includes generating information regarding power coordination (PC) indicating an amount or a range of power which is used to adjust uplink maximum transmission power of the MS, and transmitting the information regarding PC to a base station (BS). The information regarding PC is determined specifically by a uplink scheduling parameter for the MS, the number of component carriers set in the MS, and the number of radio frequencies (RFs) supported for the MS.

According to another aspect of the present invention, there is provided a method for receiving information regarding power coordination (PC) by a base station (BS) in a multi-component carrier system. The method includes receiving, from a mobile station (MS) information regarding PC indicating an amount or a range of power which is used to adjust uplink maximum transmission power of the MS, configuring an uplink grant for the MS based on the information regarding PC, transmitting, to the MS, the configured uplink grant; and receiving, from the MS, uplink data generated based on the configured uplink grant and the information regarding PC.

According to yet another aspect of the present invention, there is provided a mobile station (MS) for transmitting information regarding power coordination (PC) in a multi-component carrier system. The MS includes a PC table storage unit storing a mapping relationship between PC conditions and the amount or range of PC allowed for each of the PC conditions, wherein the PC conditions are formed by a uplink scheduling parameter of the MS, the number of component carriers configured in MS, and the number of radio frequencies (RFs) supported for MS, a PC information generation unit generating information regarding PC indicating the mapping relationship, and an RRC message transceiver unit transmitting an RRC message including the information regarding PC.

According to yet another aspect of the present invention, there is provided an is apparatus for receiving information regarding power coordination (PC) in a multi-component carrier system. The apparatus includes an RRC message transceiver unit receiving an RRC message including information regarding PC indicating an amount or a range of power which is used to adjust maximum transmission power of uplink transmission of a mobile station (MS), a scheduling unit configuring an uplink scheduling parameter, a scheduling validity determination unit determining whether or not uplink transmission based on the configured uplink scheduling parameter is made within the range of the maximum transmission power, and an uplink grant transmission unit transmitting an uplink grant comprising the configured uplink scheduling parameter.

According to yet another aspect of the present invention, there is provided a method for transmitting information regarding power coordination (PC) by a mobile station (MS) in a multi-component carrier system. The method includes generating information regarding PC indicating an amount or a range of power which is used to adjust uplink maximum transmission power required for the MS, generating a medium access control (MAC) protocol data unit (PDU) including information regarding PC, and transmitting the MAC PDU to a base station (BS). The MAC PDU includes a MAC subheader and a power coordination report (PCR) field, the PCR field includes the information regarding PC, and the MAC subheader includes a logical channel identification (ID) (LCID) indicating the PCR field.

According to yet another aspect of the present invention, there is provided a method for receiving information regarding power coordination (PC) by a base station (BS). The method includes transmitting, to a mobile station (MS), an uplink grant including a scheduling parameter regarding an uplink transmission of the MS, and receiving, from the MS, a MAC PDU generated based on the scheduling parameter. The MAC PDU includes a MAC subheader and a power coordination report (PCR) field, the MAC subheader includes logical channel identification (LCID) indicating the PCR field, and the PCR field includes information regarding PC indicating an amount or a range of power which is used to adjust uplink maximum transmission power required for the MS.

According to yet another aspect of the present invention, there is provided an apparatus for transmitting information regarding power coordination (PC) in a multi-component carrier system. The apparatus includes an uplink grant reception unit receiving an uplink grant including a scheduling parameter regarding uplink transmission, a PC information generation unit generating information regarding PC indicating an amount or a range of power which is used to adjust uplink maximum transmission power regarding a mobile station (MS), a MAC PDU generation unit configuring a MAC PDU including power coordination report (PCR) field based on a situation of resources allocated by the uplink grant, the PCR field including the information regarding PC, and a MAC PDU transmission unit transmitting the MAC PDU based on the scheduling parameter regarding uplink transmission and the information regarding PC.

According to yet another aspect of the present invention, there is provided an apparatus for receiving information regarding power coordination (PC) in a multi-component carrier system. The apparatus includes an uplink grant transmission unit transmitting an uplink grant including a scheduling parameter regarding uplink transmission, a MAC PDU reception unit receiving a MAC PDU including a MAC subheader and a power coordination report (PCR) field, and a scheduling unit determining the scheduling parameter regarding uplink transmission. The PCR field includes information regarding PC indicating an amount or a range of power which is used to adjust uplink maximum transmission power regarding the MS, and the MAC subheader includes logical channel identification (LCID) indicating the PCR field.

According to embodiments of the present invention, in the multi-component carrier system, since the range of power coordination is informed to a BS explicitly, a scheduling error in the BS due to ambiguity of power coordination can be reduced and scheduling can be performed adaptively to maximum transmission power of a provided mobile station (MS) or a component carrier.

According to embodiments of the present invention, in the multi-component carrier system, since the range of power coordination is informed to a BS explicitly, a scheduling error in the BS due to ambiguity of power coordination can be reduced and scheduling can be performed adaptively to maximum transmission power of a provided MS or a component carrier.

In particular, since information regarding power coordination determined in consideration of a communication environment of an MS is signaled, scheduling efficiency of a scheduler can be maximized.

### BRIEF DESCRIPTION OF DRAWINGS

FIG. 1 illustrates a wireless communication system.

FIG. 2 is a view for explaining the intra-band contiguous carrier aggregation.

FIG. 3 is a view for explaining the intra-band noncontiguous carrier aggregation.

FIG. 4 is a view for explaining the inter-band carrier aggregation.

FIG. 5 shows an example of a protocol structure for supporting multi-carrier.

FIG. 6 shows an example of a frame structure for a multi-carrier operation.

FIG. 7 shows a linkage between downlink component carriers and uplink component carriers in a multi-carrier system.

FIG. 8 shows an example of a graph surplus power over time-frequency axis according to an embodiment of the present invention.

FIG. 9 shows another example of a graph surplus power over time-frequency axis according to an embodiment of the present invention.

FIG. 10 is a view for explaining an amount of power coordination and maximum transmission power in a multi-component carrier system according to an embodiment of the present invention.

FIG. 11 is a flow chart illustrating a process of a method for transmitting information regarding power coordination in a multi-component carrier system according to an embodiment of the present invention.

FIG. 12 is a flow chart illustrating a process of a method for transmitting information regarding power coordination in a multi-component carrier system according to another embodiment of the present invention.

FIG. 13 is a flow chart illustrating a process of a method for transmitting information regarding power coordination by a mobile station (MS) in a multi-component carrier system according to an embodiment of the present invention.

FIG. 14 is a flow chart illustrating a process of a method for receiving information regarding power coordination by a base station in a multi-component carrier system according to an embodiment of the present invention.

FIG. 15 is a flow chart illustrating a process of a method for transmitting information regarding power coordination in a multi-component carrier system according to another embodiment of the present invention.

FIG. 16 is a flow chart illustrating a process of a method for transmitting information regarding power coordination by an MS in a multi-component carrier system according to another embodiment of the present invention.

FIG. 17 is a flow chart illustrating a process of a method for receiving information regarding power coordination by a base station in a multi-component carrier system according to another embodiment of the present invention.

FIG. 18 is a schematic block diagram showing an apparatus for transmitting information regarding power coordination and an apparatus for receiving information regarding power coordination in a multi-component carrier system according to an embodiment of the present invention.

FIG. 19 is a conceptual view showing the influence of uplink scheduling of BS on transmission power of an MS in a wireless communication system.

FIG. 20 is a block diagram showing the structure of a MAC PDU for a power coordination report according to an embodiment of the present invention.

FIG. 21 is a block diagram showing the structure of a MAC PDU for a power coordination report according to another embodiment of the present invention.

FIG. 22 is a block diagram showing the structure of a MAC PDU for a power coordination report according to another embodiment of the present invention.

FIG. 23 is a flow chart illustrating a process of a method for transmitting information regarding power coordination according to an embodiment of the present invention.

FIG. 24 is a flow chart illustrating a process of a method for transmitting information regarding power coordination by an MS according to an embodiment of the present invention.

FIG. 25 is a flow chart illustrating a process of a method for receiving information regarding power coordination by a BS according to an embodiment of the present invention.

FIG. 26 is a schematic block diagram showing an apparatus for transmitting information regarding power coordination and an apparatus for receiving information regarding power coordination in a multi-component carrier system according to an embodiment of the present invention.

### DETAILED DESCRIPTION OF THE ILLUSTRATED EMBODIMENTS

Exemplary embodiments of the present invention will now be described in detail with reference to the accompanying drawings. The same or similar elements are designated with the same numeral references regardless of the numerals in the drawings and their redundant description will be omitted. In describing the present invention, moreover, the detailed description will be omitted when a specific description for publicly known technologies to which the invention pertains is judged to obscure the gist of the present invention.

In describing the elements of the present invention, terms such as first, second, A, B, (a), (b), etc., may be used. Such terms are used for merely discriminating the corresponding elements from other elements and the corresponding elements are not limited in their essence, sequence, or precedence by the terms. It will be understood that when an element or layer is referred to as being “on” or “connected to” another element or layer, it can be directly on or directly connected to the other element or layer, or intervening elements or layers may be present.

In the present disclosure, a wireless communication network will be described, and an operation performed in the wireless communication network may be performed in a process of controlling a network and transmitting data by a system (e.g., a base station (BS)) administering the corresponding wireless communication network or may be performed in a is mobile station (MS) connected to the corresponding wireless network.

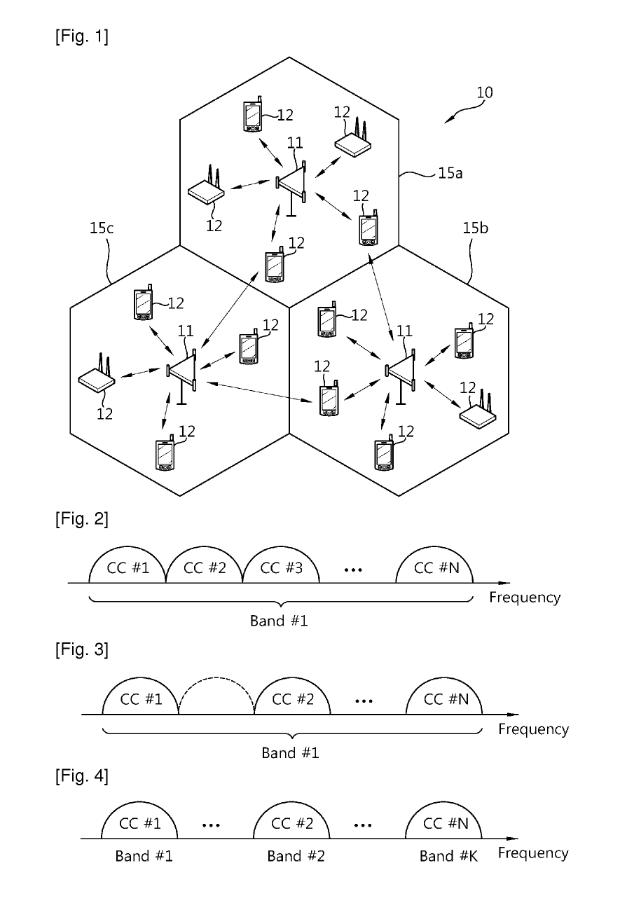

FIG. 1 illustrates a wireless communication system.

With reference to FIG. 1, the wireless communication system 10 is widely disposed to provide various communication services such as voice and packet data, or the like.

The wireless communication system 10 includes at least one base station (BS) 11. Each BS 11 provides a communication service to particular geographical areas or particular frequency areas (which are generally called cells) 15a, 15b, and 15c. The cells may be divided into a plurality of areas (which are generally called sectors).

A mobile station (MS) 12 may be fixed or mobile and may be referred to by other names such as user equipment (UE), mobile terminal (MT), user terminal (UT), subscriber station (SS), wireless device, personal digital assistant (PDA), wireless modem, handheld device, etc.

The BS 11 generally refers to a station that communicates with the MS 12 and may be called by other names such as evolved-node B (eNB), base transceiver system (BTS), access point (AP), etc. Cells 15a, 15b, and 15c may be construed to have a comprehensive meaning indicating partial areas covered by the BS 11, and may include various coverage areas such as a mega-cell, a macro-cell, a micro-cell, a pico-cell, a femto-cell, and the like.

Hereinafter, downlink (DL) refers to communication from the BS 11 to the MS 12, and uplink (UL) refers to communication from the MS 12 to the BS 11. In downlink, a transmitter may be part of the BS 11 and a receiver may be part of the MS 12. In uplink, a transmitter may be part of the MS 12 and a receiver may be part of the BS 11.

There is not limitation in multi-access schemes applied to the wireless communication. Namely, various multi-access schemes such as CDMA (Code Division is Multiple Access), TDMA (Time Division Multiple Access), FDMA (Frequency Division Multiple Access), OFDMA (Orthogonal Frequency Division Multiple Access), SC-FDMA (Single Carrier-FDMA), OFDM-FDMA, OFDM-TDMA, OFDM-CDMA, or the like, may be used. A TDD (Time Division Duplex) scheme in which transmission is made by using a different time or an FDD (Frequency Division Duplex) scheme in which transmission is made by using different frequencies may be applied to an uplink transmission and a downlink transmission.

A carrier aggregation (CA) supports a plurality of carriers, which is also called a spectrum aggregation or a bandwidth aggregation. Individual unit carriers grouped through carrier aggregation are called component carriers (CCs). Each of the component carriers (CCs) is defined by bandwidth and central frequency. The carrier aggregation is introduced to support increased throughput, prevent an increase in cost otherwise caused by an introduction of a broadband radio frequency (RF) element, and guarantee compatibility with an existing system.

For example, when five component carriers are allocated as granularity of carrier unit having a 5 MHz bandwidth, a maximum 20 MHz bandwidth can be supported.

The carrier aggregation may be divided into an intra-band contiguous carrier aggregation as shown in FIG. 2, an intra-band non-contiguous carrier aggregation as shown in FIG. 3, and an inter-band carrier aggregation as shown in FIG. 4.

First, with reference to FIG. 2, the intra-band carrier aggregation (CA) is made among continuous component carriers in the identical band. For example, CC#1, CC#2, CC#3, . . . , CC#N, aggregated CCs, are all adjacent to each other.

With reference to FIG. 3, an intra-band non-contiguous CA is made among discontinuous CCs. For example, CC#1 and CC#2, aggregated CCs, are spaced apart by a is particular frequency.

With reference to FIG. 4, an inter-band CA is made as one or more CCs are aggregated in different frequency bands when a plurality of CCs exist. For example, CC#1, an aggregated CC, exists in band #1, CC#2, an aggregated CC, exists in band #2.

The number of aggregated carriers may be set to be different for downlink and uplink. An aggregation in which the number of downlink component carriers is equal to the number of uplink component carriers is called a symmetric aggregation, and an aggregation in which the number of downlink component carriers is different from the number of uplink component carriers is called an asymmetric aggregation.

Sizes (i.e., bandwidths) of component carriers may vary. For example, when five component carriers are used to configure a 70 MHz band, the five carriers may be configured as follows: 5 MHz CC (carrier #0)+20 MHz CC (carrier #1)+20 MHz CC (carrier #2)+20 MHz CC (carrier #3)+5 MHz CC (carrier #4).

Hereinafter, a multi-carrier system refers to a system supporting carrier aggregation. In the multi-carrier system, a contiguous carrier aggregation and/or a non-contiguous carrier aggregation may be used, or either the symmetrical aggregation or the asymmetrical aggregation may be used.

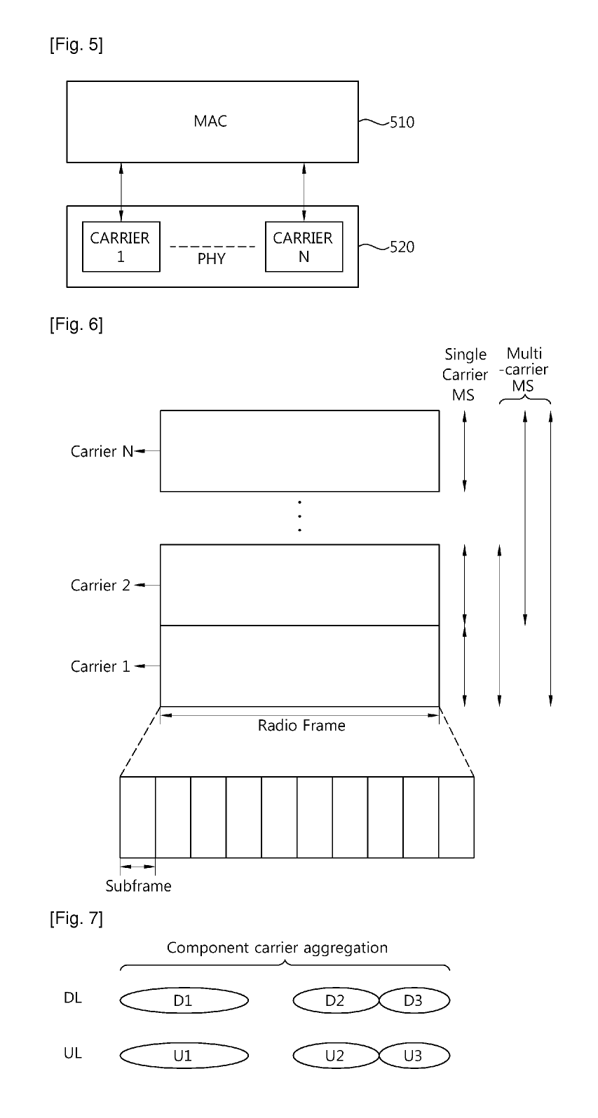

FIG. 5 shows an example of a protocol structure supporting multiple carriers.

With reference to FIG. 5, a common medium access control (MAC) entity 510 manages a physical (PHY) layer 520 using a plurality of carriers. A MAC management message transmitted in a particular carrier may be applied to a different carrier. Namely, the MAC management message can control other carriers including the particular carrier. The PHY layer 520 may operate according to TDD (Time Division Duplex) and/or FDD (Frequency Division Duplex).

Some physical control channels are used in the PHY layer 520. A PDCCH (physical downlink control channel) provides an MS with information regarding a resource allocation of a PCH (paging channel) and DL-SCH (downlink shared channel) HARQ (hybrid automatic repeat request) related to the DL-SCH. The PDCCH may carry an uplink grant informing the MS about an resource allocation of uplink transmission.

A PCFICH (physical control format indicator channel) informs the MS about the number of OFDM symbols used for the PDCCHs, and is transmitted at every subframe. A PHICH (physical Hybrid ARQ Indicator Channel) carries an HARQ ACK/NAK signal in response to uplink transmission. A PUCCH (Physical uplink control channel) carries uplink control information such as a CQI, an HARQ ACK/NAK signal with respect to downlink transmission, and a scheduling request. A PUSCH (physical uplink shared channel) carries a UL-SCH (uplink shared channel).

The MS transmits the PUCCH or the PUSCH as follows.

The MS configures the PUCCH with respect to one or more information among information regarding a precoding matrix index (PMI) or a rank indicator (RI) selected based on a channel quality information (CQI) or measured space channel information, and periodically transmits the PUCCH to the BS.

Also, the MS must transmit information regarding an ACK/NACK (Acknowledgement/non-acknowledgement) regarding downlink data received from the BS to the BS after a certain number of subframes upon receiving the downlink data. For example, when downlink data is received in an nth subframe, the MS transmits a PUCCH including ACK/NACK information with respect to the downlink data in (n+4) subframe.

When CQI or ACK/NACK information cannot be transmitted on the PUCH allocated from the BS, or when a PUCCH for transmitting CQI or ACK/NACK is not allocated from the BS, or when transmissions of PUCCH and PUSCH are defined in the same subframe and simultaneous transmission of the PUCCH and the PUSCH is not available, the MS may carry and transmit CQI or ACK/NACK information in the PUSCH to the BS only when it is determined that transmission including uplink control information (UCI) information can be made in the PUSCH.

FIG. 6 shows an example of a frame structure for a multi-carrier operation.

With reference to FIG. 6, a radio frame includes 10 subframes. Each of the subframes includes a plurality of OFDM symbols. Each CC may have its own control channel (e.g., a PDCCH). The CCs may be contiguous or may not. The MS may support one or more CCs according to its capability.

Component carriers (CCs) may be divided into a primary component carrier (PCC) and a secondary component carrier (SCC) depending on whether or not they are activated. The primary component carrier is a constantly activated carrier, and the secondary component carrier is a carrier activated or deactivated according to particular conditions.

Here, activation refers to a state in which traffic data is transmitted or received or a state in which traffic data and control information related to resource allocation for the traffic data are ready to be transmitted or received. Deactivation refers to a state in which traffic data cannot be transmitted or received and measurement or transmission or reception of minimum information is available.

The MS may use only one primary component carrier or one or more secondary component carriers along with a primary component carrier. The MS may be allocated the primary component carrier and/or the secondary component carrier from the BS. The primary component carrier may be a fully configured component carrier, through which major control information between the BS and the MS is exchanged. The secondary component carrier may be a fully configured carrier or a partially configured carrier, which is allocated according to a request from the MS or according to an instruction of the BS. The primary component carrier may be used for a network entry of the MS and/or an allocation of the secondary component carrier. The primary component carrier is not a fixed carrier but can be differently selected by each MS or the BS from among fully configured carriers. A carrier set as the secondary component carrier may be changed to the primary component carrier.

FIG. 7 illustrates a linkage between downlink component carriers and uplink component carriers in the multi-carrier system.

With reference to FIG. 7, downlink component carriers (DL CC) D1, D2, and D3 are aggregated in downlink, and uplink component carriers (UL CC) U1, U2, and U3 are aggregated in uplink. Here, Di is an index (i=1, 2, 3) of the DL CC, and Ui is an index of UL CC. At least one DL CC is a primary component carrier (PCC), and the other remaining DLCC are secondary component carriers (SCC). Similarly, at least one UL CC is a PCC, and the other remaining UL CCs are SCCs. For example, D1 and U1 are PCCs, and D2, U2, D3, and U3 are SCCs.

In an FDD system, the DL CCs and the UL CCs are set to be connected by 1:1, and in this case, D1 is set to be connected to U1, D2 to U2, and D3 to U3, in a one-to-one manner. The MS sets the linkage between the DL CCs and the UL CCs through system information transmitted by a logical channel BCCH or an MS-dedicated RRC message transmitted by a DCCH. Each linkage may be set to be cell-specific or may MS-specific.

FIG. 7 illustrates only the 1:1 linkage between the DL CCs and the UL CCs, but of course, a linkage of 1:n or a linkage of n:1 can be established. Also, the index of the component carriers may not be consistent with order of CCs or the position of a frequency band of corresponding CCs.

A primary serving cell refers to a serving cell providing a security input and Non-access stratum (NAS) mobility information in a state in which an RRC is established or re-established. At least one cell may be configured to form a set of serving cells along with a primary serving cell according to capabilities of the MS, and in this case, the at least one cell is called a secondary service cell.

Thus, the set of serving cells configured for one MS may include only a single primary serving cell or may include one primary serving cell and one or more secondary serving cells.

A DL CC corresponding to a primary serving cell is called a downlink primary component carrier (DL PCC), and an UL CC corresponding to a primary serving cell is called an uplink primary component carrier (UL PCC). Also, in downlink, a CC corresponding to a secondary serving cell is called a downlink secondary component carrier (DL SCC), and in uplink, a CC corresponding to a secondary serving cell is called an uplink secondary component carrier (UL SCC). The DL CC only may correspond to one serving cell, or the DL CC and the UL CC may correspond together to one serving cell.

Hereinafter, all embodiments disclosed in the present invention describe their subject matters in terms of CC. But it is obvious and possible to those skilled in the art to replace a CC for a serving cell with regard to those subject matters.

A power headroom (PH) will now be described.

A power headroom (PH) refers to extra power which can be additionally used in addition to power currently used for uplink transmission by the MS. For example, it is assumed that maximum transmission power, transmission power within an allowable range, of the MS is 10 W. It is also assumed that the MS currently uses 9 W in a frequency band of 10 MHz. The MS can additionally use 1 W, so PH is 1 W.

Here, when the BS allocates a frequency band of 20 MHz to the MS, power of 9×2=18 W is required. However, since the maximum power of the terminal 10 W, when power of 20 MHz is allocated to the MS, the MS cannot use the entirety of the frequency band or power may be insufficient so the BS cannot properly receive a signal from the MS. Thus, in order to solve this problem the MSS reports the BS that power headroom is 1 W, so that the BS can perform scheduling within the range of power headroom. Such a report is called a power headroom report (PHR).

Since the PH is frequently changed, periodic PHR scheme may be used. According to the periodic PHR scheme, when a periodic timer expires, the MS triggers the PHR, and when the PH is reported, the MS reoperates the periodic timer.

Also, when a pass loss (PL) estimate value measured by the MS is changed by more than a certain reference value, the PHR may be triggered. The PL estimate value is measured by the MS based on a reference symbol received power (PSRP).

The PH (Pp_{H}) is defined as the difference between maximum transmission power Pmax set in the MS as represented by Math figure 1 and power Pestimated estimated regarding uplink transmission, and it is expressed as dB.

P_{PH}=Pₘₐₓ−P_{estimated [dB]} [Math figure 1]

Power headroom (P_{PH}) may also be called remaining power or surplus power. Namely, a remainder value, excluding P_{estimated}, the sum of transmission power used by each CC, in the maximum transmission power of the MS set by the BS, is P_{PH}.

For example, P_{estimated} is equal to power P_{PUSCH} estimated regarding transmission of physical uplink shared channel (PUSCH). Thus, in this case, P_{PH} can be obtained by Math FIG. 2 shown below:

P_{PH}=Pₘₐₓ−P_{PUSCH}[dB] [Math figure 2]

In another example, P_{estimated} is equal to the sum of power P_{PUSCH} estimated regarding transmission of the PUSCH and power P_{PUCCH} estimated regarding transmission of physical uplink control channel (PUCCH). Thus, in this case, power headroom (PH) can be obtained by Math figure 3 shown below:

P_{PH}=Pₘₐₓ−P_{PUCCH}−P_{PUSCH}[dB] [Math figure 3]

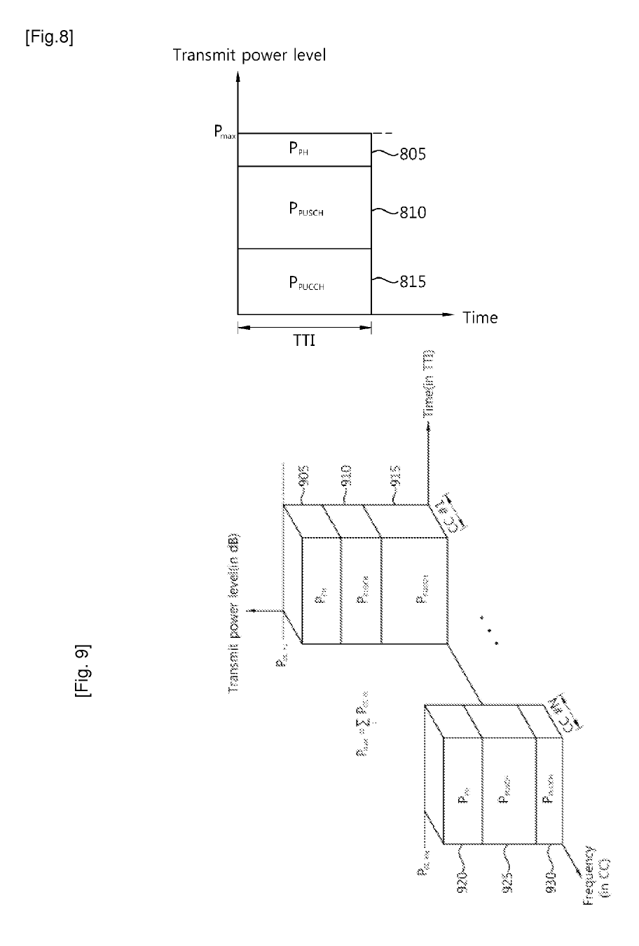

The PH according to Math figure 3 can be expressed on time and frequency axes in a graph as shown in FIG. 8. In FIG. 8, PH with respect to one CC is shown.

With reference to FIG. 8, the set maximum transmission power Pmax of the MS includes P_{PH} (805), P_{PUSCH} (810) and P_{PUCCH} (815). Namely, the remainder, excluding P_{PUSCH}(810) and P_{PUCCH} (815), in Pmax is defined as P_{PH} (805). Each power is calculated by transmission time interval (TTI).

A main serving cell is the only serving cell retaining a UL PCC for transmitting the PUCCH. Thus, a sub-serving cell cannot transmit the PUCCH, PH is determined as is expressed by Math figure 2, and a parameter and an operation with respect to the PHR method determined by Math figure 3 are not defined.

Meanwhile, in the main serving cell, operation and parameters with respect to a PHR method determined by Math figure 3 may be defined. When MS receives an uplink grant from the BS so it should transmit the PUSCH and simultaneously transmits the PUCCH in the same subframe according to a determined rule in the main serving cell, the MS calculates all the PHs according to Math figure 2 and Math figure 3 at a point in time at which the PHR is triggered, and transmits the same to the BS.

In the multi-component carrier system, PH can be individually defined regarding a plurality of set CCs, and FIG. 9 shows a graph in which PH is expressed on time and frequency axes.

With reference to FIG. 9, the maximum transmission power Pmax set n the MS is equal to the sum of maximum transmission power P_{CC#1}, P_{CC #2}, . . . , P_{CC #N} with respect to respective CC #1, CC #2, . . . , and CC #N. The maximum transmission power per CC can be generalized as expressed by Math figure 4 shown below:

$${P}_{{CC}_{i}} = {P}_{max} - {\sum }_{j \neq i} {P}_{{CC}_{j}} \qquad [ Math Figure 4 ]$$

P_{PH}(905) of CC #1 is equal to P_{CC#1}−P_{PUSCH} (910)−P_{PUCCH}(915), and P_{PH}(920) is equal to P_{CC #n}-P_{PUSCH}(925)−P_{PUCCH}(930). In this manner, for the maximum transmission power set in the MS in the multi-component carrier system, the maximum transmission power of each CC must be considered. Thus, the maximum transmission power in the multi-component carrier system is defined to be different from that in a single component carrier system.

No matter whether it is a single component carrier system or it is a multi-component carrier system, the maximum transmission power set in the MS is affected by power coordination (PC) of the MS. PC refers to reducing the maximum transmission power set in the MS within a certain allowed range, and it may be called a maximum power reduction (MPR). The reduced amount of power according to PC is called a PC amount. The reason for reducing the maximum transmission power set in the MS is as follows. It happens that the maximum transmission power is required to be limited due to the form of a signal to be currently transmitted based on hardware configuration (in particular, radio frequency (RF)) in the MS.

Here, the hardware configuration in the MS includes RF, and this is may also be called an RF chain. The RF is characteristic in that it includes a combination of a power amplifier, a filter, an antenna, and the like, in the hardware configuration of the MS. Also, the RF may be defined by each of the power amplifier, the filter, and the antenna. One RF may be configured in one MS or a plurality of RFs may be configured in one MS. For example, when an MS has one antenna, the antenna is connected to a first power amplifier connected to a first filter, and simultaneously, the antenna is connected to a second power amplifier connected to a second filter, then, the one terminal constitutes two RF chains.

When an uplink transmission bandwidth is determined, a corresponding signal is controlled to be transmitted only with respect to a bandwidth set by the filter. Here, as the width of the bandwidth is larger, the number of taps (e.g., registers) constituting the filter is increased. In order to satisfy ideal filter characteristics, design complexity and size of the filter increased exponentially in spite of the identical bandwidth.

Thus, interference power with respect to a band which is not to be transmitted to uplink due to the characteristics of the filter may be generated. In order to reduce such interference power, the interference power is required to be reduced by reducing the maximum transmission power through PC. The range of the maximum transmission power in consideration of PC is expressed by Math figure 5 shown below;

P_{max-L}≦Pₘₐₓ≦P_{max-H} [Math figure 5]

Here, Pₘₐₓ is the maximum transmission power set in the MS, P_{max-L} is the lowest value of Pmax, and P_{max-H} is the highest value of Pₘₐₓ. In detail, P_{max-L} and P_{max-H} are calculated by Math figure 6 and Math figure 7, respectively, shown below:

P_{max-L}=MIN[P_{Emax}−ΔT_{C},P_{powerclass}−PC−APC−ΔT_{C}] [Math figure 6]

P_{max-H}=MIN[P_{Emax},P_{powerclass}] [Math figure 7]

Here, MIN[a,b] is a smaller value among a and b, P_{Emax} is maximum power determined by RRC signaling of the BS, and ΔT_{C} is an amount of power applied at an edge of a band when there is uplink transmission, which has a value of 1.5 dB or 0 dB according to a bandwidth. P_{powerclass} is a power value according to several power classes defined to supply the specifications of various MSs in the system.

In general, in the LTE system, power class 3 is supported and P_{powerclass} by power class 3 is 23 dBm. PC is power coordination amount, and APC (additional power coordination) is an additional power coordination amount signaled by the BS. PC may be set to be within a particular range, or may be set as a particular constant. PC may be defined by MS, by CC, or by range or constant in each CC unit. Also PC may be set by a range or a constant according to whether or not a PUSCH resource allocation of each CC is continuous or discontinuous. Also, PC may be set by a range or a constant according to whether or not PUCCH exists.

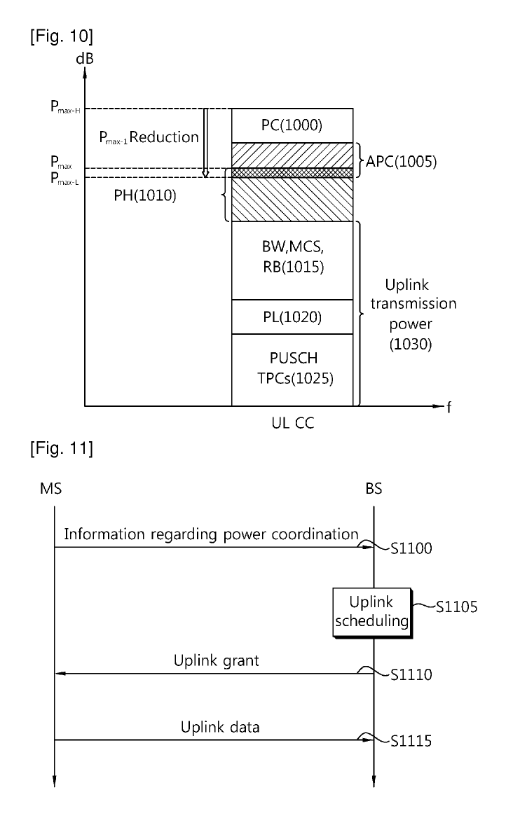

FIG. 10 is a view for explaining an amount of power coordination and maximum transmission power in a multi-component carrier system according to an embodiment of the present invention. It is assumed that only one UL CC is allocated to an MS for the sake of brevity.

With reference to FIG. 10, when it is assumed that ΔT_{C}=0, it is noted that the highest value P_{max-H} of the maximum transmission power Pₘₐₓ is 23 dB which corresponds to power class 3. The lowest value P_{max-L} of the maximum transmission power Pₘₐₓ is a value obtained by subtracting the power coordination amount PC 1000 and additional power coordination amount APC 1005 from the height value P_{max-H}. Namely, the MS reduces the lowest value P_{max-L} of the maximum transmission power Pₘₐₓ by using the power coordination amount PC 1000 and the additional power coordination amount APC 1005. The maximum transmission power Pmax is determined between the highest value P_{max-H} and the lowest value P_{max-L}.

Meanwhile, uplink transmission power 1030 appears as the sum of power 1015 determined by bandwidth (BW), MCS, and RB, a pass loss (PL) 1020, and PUSCH transmission power control (TPCs) 1025. PH 1010 is a value obtained by subtracting the uplink transmission power 1030 from the maximum transmission power Pₘₐₓ.

In FIG. 10, only one UL CC is explained, but when a plurality of UL CCs are allocated, maximum transmission power will be given by terminal, rather than by UL CC, and MS-specific maximum transmission power may be given by the sum of the respective maximum transmission powers with respect to all the UL CCs. Or the maximum transmission power specific to the MS may be limited to a maximum transmission power of one UL CC.

Table 1 below shows an example of power coordination designed for a single CC system. This shows a power coordination (PC) amount in case of power class 3.

TABLE 1

| | Channel bandwidth/ | | | | | | |
|---|---|---|---|---|---|---|---|
| | Transmission bandwidth configuration (RB) | | | | | | |
| | | 3.0 | | | 15 | 20 | PC |
| Modulation | 1.4 MHz | MHz | 5 MHz | 10 MHz | MHz | MHz | (dB) |
| QPSK | >5 | >4 | >8 | >12 | >16 | >18 | ≦1 |
| 16 QAM | ≦5 | ≦4 | ≦8 | ≦12 | ≦16 | ≦18 | ≦1 |
| 16 QAM | >5 | >4 | >8 | >12 | >16 | >18 | ≦2 |

With reference to Table 1, modulation, channel bandwidth, and resource block (RB) are factors determined by uplink scheduling of the BS. The PC amount should satisfy the requirements of Table 1.

For example, when 16 QAM (Quadrature Amplitude Modulation) and 18 RB are scheduled in a 20 MHz system for the MS, a maximum value of the PC amount of the corresponding MS is up to 2 dB. Thus, the MS may be designed such that the set maximum transmission power is reduced to 2 dB.

In this manner, the MS is to be designed to satisfy a certain range (PC?1 dB or PC?2 dB) under the scheduling conditions of the modulation/channel bandwidth/RB of Table 1. The reason why the PC amount has the characters of requirements is because the PC amount may be different set for each MS according to an implementation form of each MS or the characteristics of a power amplifier.

For example, a power coordination amount of a high-end MS is not much changed according to a change in the scheduling parameter, but a low-end MS may experience a great change of power coordination amount.

In calculating the maximum transmission power, P_{Emax}, ΔT_{C}, P_{powerclass}, and additional power coordination (APC) amount are information the BS knows about or may know about. However, the BS cannot know about the power coordination (PC) amount, so it cannot precisely know about the maximum transmission power according to the power coordination (PC) amount. In this case, when the MS reports PH to the BS, the BS can merely estimate about in which range the maximum transmission power will be in sub-frames in which the MS calculated the PH, through the PH.

Thus, the BS performs uncertain uplink scheduling within the estimated maximum transmission power, so in a worst-case scenario, the BS may possibly perform scheduling with modulation/channel bandwidth/RB requiring transmission power higher than the maximum transmission power from the MS. This problem may severely arise in the multi-component carrier system.

For example, when a plurality of CC exist and/or when one or more RFs exist, various communication environments would be established and a large number of uplink scheduling would be performed. This means that variance of power coordination would also be too various to be estimated.

Thus, there is a need to newly design power coordination according to various numbers of cases in consideration of CC and RF as well as uplink scheduling parameters (modulation, channel bandwidth, the number of RBs, etc.).

Hereinafter, a definition, a format, a transmission procedure of information regarding power coordination, and a message structure will now be described in detail.

1. Information Regarding Power Coordination (or Power Coordination Information (PCI)

When communication environments are not various, the range of power coordination of about 1 dB to 2 dB can be covered. In this case, the BS can easily estimate the range of power coordination, so the BS can perform scheduling without difficulties even without information regarding power coordination.

However, the MS may encounter various communication environments specifically defined by the combination of the number of aggregatable CCs, the number of available RFs, a modulation scheme, an allocated frequency bandwidth, and the amount of resource blocks.

For example, a certain communication environment may be specified by two CCs, one RF, 16 QAM, 20 MHz bandwidth, and ten resource blocks, while a different communication environment may be specified by one CC, one RF, QPSK modulation, 10 MHz bandwidth, and five resource blocks. Namely, the respective communication environments may have a large number of cases. Various communication environments inevitably require various variances with respect to power coordination.

Thus, the MS is required to support various power coordination amounts or ranges with respect to various communication environments, and the BS is required to know about the various power coordination amounts or ranges supported by the MS to perform accurate scheduling. For accurate scheduling, the BS requires information regarding power coordination.

Information regarding power coordination explicitly or implicitly indicates an amount or a range of power which is used to adjust uplink maximum transmission power regarding the MS. When information regarding power coordination is a PC table index or a parameter indicating hardware characteristics of the MS, although the amount or a range of power coordination is not directly informed to the BS, the BS can indirectly know about the amount or the range of power coordination based on the information.

The information regarding power coordination is defined as information regarding an amount or a range of power to by which the uplink maximum transmission power regarding the MS is to be adjusted. The information regarding power coordination provides an amount or a range of power coordination specified for respective various communication environment conditions the MS may encounter. The information regarding power coordination is determined specifically by conditions formed by at least one of the number of CCs configured in the MS and the number of radio frequencies (RFs) supported for the MS.

Because the MS explicitly or implicitly provides the information regarding power coordination to the BS, a scheduling error of the BS due to ambiguity of power coordination can be reduced and the BS can perform scheduling such that it is adaptive to the maximum transmission power for a given MS or for each CC.

2. Format of Information Regarding Power Coordination (PC)

Information regarding PC may be in various formats such as a table, an index, and an aggregation of various information elements.

For example, information regarding PC may be configured in a table format indicating a mapping relationship between PC conditions and the amount or range of PC allowed for each of the PC conditions, wherein the PC conditions are formed by a uplink scheduling parameter of the MS, the number of component carriers configured in MS, and the number of radio frequencies (RFs) supported for MS.

Table 2 below shows an example in which information regarding PC is configured as a table. In this case, a total number of aggregatable CCs of the MS is 5, power class is 3, and supportable RFs are 2.

TABLE 2

| | | Channel bandwidth/ | | | | | | |
|---|---|---|---|---|---|---|---|---|
| | | Transmission bandwidth configuration (RB) | | | | | | PC (dB) |
| | Modulation | 1.4 MHz | 2.5 MHz | 5 MHz | 10 MHz | 15 MHz | 20 MHz | PC (dB) |
| #CCs = 1, | QPSK | >5 | >4 | >8 | >12 | >16 | >18 | ≦1 |
| #RF = 1 | | | | | | | | |
| #CCs = 1, | 16QAM | ≦5 | ≦4 | ≦8 | ≦12 | ≦16 | ≦18 | ≦1 |
| #RF = 1 | | | | | | | | |
| #CCs = 1, | 16QAM | >5 | >4 | >8 | >12 | >16 | >18 | ≦2 |
| #RF = 1 | | | | | | | | |
| #CCs = 2, | QPSK, QPSK | >5, >5 | >4, >4 | >8, >8 | >12, >12 | >16, >16 | >18, >18 | 3 ≦ x ≦ 4 |
| #RF = 1 | | | | | | | | |
| #CCs = 2, | QPSK, 16QAM | >5, ≦5 | >4, ≦4 | >8, ≦8 | >12, ≦12 | >16, ≦16 | >18, ≦18 | 3 ≦ x ≦ 4 |
| #RF = 1 | | | | | | | | |
| #CCs = 2, | QPSK, 16QAM | >5, >5 | >4, >4 | >8, >8 | >12, >12 | >16, >16 | >18, >18 | 5 ≦ x ≦ 6 |
| #RF = 1 | | | | | | | | |
| #CCs = 2, | 16QAMx2 | ≦5, ≦5 | ≦4, ≦4 | ≦8, ≦8 | ≦12, ≦12 | ≦16, ≦16 | ≦18, ≦18 | 3 ≦ x ≦ 4 |
| #RF = 1 | | | | | | | | |
| #CCs = 2, | 16QAMx2 | >5, ≦5 | >4, ≦4 | >8, ≦8 | >12, ≦12 | >16, ≦16 | >18, ≦18 | 5 ≦ x ≦ 6 |
| #RF = 1 | | | | | | | | |
| #CCs = 2, | 16QAMx2 | >5, >5 | >4, >4 | >8, >8 | >12, >12 | >16, >16 | >18, >18 | 8 ≦ x ≦ 10 |
| #RF = 1 | | | | | | | | |
| #CCs = 2, | QPSK, QPSK | >5, >5 | >4, >4 | >8, >8 | >12, >12 | >16, >16 | >18, >18 | ≦2 |
| #RF = 2 | | | | | | | | |
| #CCs = 2, | QPSK, 16QAM | >5, ≦5 | >4, ≦4 | >8, ≦8 | >12, ≦12 | >16, ≦16 | >18, ≦18 | 3 ≦ x ≦ 5 |
| #RF = 2 | | | | | | | | |
| #CCs = 2, | QPSK, 16QAM | >5, >5 | >4, >4 | >8, >8 | >12, >12 | >16, >16 | >18, >18 | 5 ≦ x ≦ 7 |
| #RF = 2 | | | | | | | | |
| #CCs = 2, | 16QAMx2 | ≦5, ≦5 | ≦4, ≦4 | ≦8, ≦8 | ≦12, ≦12 | ≦16, ≦16 | ≦18, ≦18 | 5 ≦ x ≦ 7 |
| #RF = 2 | | | | | | | | |
| #CCs = 2, | 16QAMx2 | >5, ≦5 | >4, ≦4 | >8, ≦8 | >12, ≦12 | >16, ≦16 | >18, ≦18 | 7 ≦ x ≦ 9 |
| #RF = 2 | | | | | | | | |
| #CCs = 2, | 16QAMx2 | >5, >5 | >4, >4 | >8, >8 | >12, >12 | >16, >16 | >18, >18 | 9 ≦ x ≦ 11 |
| #RF = 2 | | | | | | | | |

. . . . . .

| | | | | | | | | |
|---|---|---|---|---|---|---|---|---|
| #CCs = 5, | QPSK, QPSK, | >5, >5, >5, | >4, >4, | >8, >8, | >12, >12, | >16, >16, | >18, >18, | ≦2 |
| #RF = 2 | QPSK, QPSK, | >5, >5 | >4, >4, | >8, >8, | >12, >12, | >16, >16, | >18, >18, | |
| | QPSK | | >4 | >8 | >12 | >16 | >18 | |
| #CCs = 5, | QPSK, QPSK, | >5, >5, >5, | >4, >4, | >8, >8, | >12, >12, | >16, >16, | >18, >18, | 2 ≦ x ≦ 4 |
| #RF = 2 | QPSK, QPSK, | >5, ≦5 | >4, >4, | >8, >8, | >12, >12, | >16, >16, | >18, >18, | |
| | 16QAM | | ≦4 | ≦8 | ≦12 | ≦16 | ≦18 | |
| #CCs = 5, | . | . | . | . | . | . | . | . |
| #RF = 2 | . | . | . | . | . | . | . | . |
| | . | . | . | . | . | . | . | . |
| #CCs = 5, | 16QAM | >5, >5, >5, | >4, >4, | >8, >8, | >12, >12, | >16, >16, | >18, >18, | 10 ≦ x ≦ 12 |
| #RF = 2 | | >5, >5 | >4, >4, | >8, >8, | >12, >12, | >16, >16, | >18, >18, | |
| | | | >4 | >8 | >12 | >16 | >18 | |

With reference to Table 2, #CCs are the number of actually set CCs among the entire aggregatable CCs in the MS, and #RF is the number of actually used RFs among the entire supportable RFs. Table 2 defines the amount or range of PC in a communication environment under various conditions specified by the number of CCs regarding the MS, the number of RFs, modulation, channel bandwidth, and the number of resource blocks (RBs).

It is assumed that a communication environment of #CCs=5 and #RF=2 is set in the MS. If five CCs are modulated by QPSK, QPSK, QPSK, QPSK, and 16QAM, respectively, and 20 RBs are scheduled for each of the five CCs, then, the range of power coordination of the corresponding MS is 2 dB to 4 dB. Thus, the MS can reduce set maximum transmission power by 2 dB to 4 dB.

Table 2 shows an example in which the total number of aggregatable CCs of the MS is 5, power class is 3, and supportable RFs is 2, which are factors for determining a unique specification of the MS. These may be fixedly stored in the MS when the MS was designed.

Thus, a new table may be defined by a new combination of the number of aggregatable CCs, the number of supportable RFs, and power class. Here, since the BS cannot know about the table, the MS transmits the table itself as information regarding PC to the BS. Hereinafter, the table related to PC will be referred to as PC table.

The PC table informs about an amount or a range of PC allowed for the MS under each of PC conditions formed by at least one of a scheduling parameter with respect to the MS, the number of CCs configured in the MS, and the number of RFs supported for the MS. Thus, since the BS can know about the PC conditions, when the BS explicitly receives the PC table, it can estimate the amount or the range of PC according to the PC conditions. The PC can set a scheduling parameter such that it does not exceed the uplink maximum transmission power of the MS based on the estimated amount or range of PC and the PHR by the MS.

In another example, the information regarding PC may be configured in the form of an index. Namely, the information regarding PC may indicate a certain condition formed by a uplink scheduling parameter of the MS, the number of component carriers set in the MS, and the number of radio frequencies (RFs) supported for the MS, and an amount or a range of power coordination allowed for the certain condition.

Table 3 below shows an example of configuring information regarding PC as an index.

TABLE 3

| Index | 1 | 2 | . . . | N − 1 | N |
|---|---|---|---|---|---|
| Table | table 1 | table 2 | . . . | table N − 1 | table N |
| Number | | | | | |

With reference to Table 3, when it is assumed that N number of PC tables as shown in Table 2 is defined in a current system according to specification of the MS, each of the PC tables is identified by indexing.

Since the MS only needs to transmit only the index of PC table, as information regarding PC, to the BS, overhead can be considerably reduced compared with the case in which all of the N number of PC tables are transmitted. In this case, the MS and the BS should have the PC tables of all the cases supported in the system and indexes of the respective PC tables stored in a memory.

When the number of PC tables is N, N number of indexes indicating all of the N number of PC tables are required. The number of bits which can express all of the N number of indexes is ceiling(log₂(N)). Here, ceiling(x) is a minimum integer greater than x. For example, when ten tables exist, since ceiling (log₂(10))=4, information regarding PC has 4 bits.

When information regarding PC in the form of index is received, the BS may select a particular PC table indicated by the index and perform scheduling with reference to the selected PC table.

In another example, the information regarding PC may be configured in the form of an aggregation of various information elements. The information element is a parameter indicating hardware characteristics regarding PC, which includes a power class, the number of is supportable transmission and reception RFs, and the number of aggregatable CCs of the MS. A PC table may be specified by a combination of information elements. For example, it is assumed that information regarding PC is configured as shown in Table 4 below.

TABLE 4
Information regarding PC

| | |
|---|---|
| Powerclass | 3 |
| RF | 2 |
| Aggregatable CC | 5 |

Since the power class of the MS is 3, the supportable RFs is 2, and aggregatable CCs is 5, the PC table of Table 2 can be specified. Here, the MS and the BS should have PC tables of all the cases stored in the memory. When the MS provides the information regarding PC configured with various information elements to the BS, the BS may select a PC table specified by the information elements from among all the PC tables stored in the memory and performs uplink scheduling.

3. Transmission of Information Regarding PC

The MS in an idle mode may transmit the information regarding PC by using an RRC connection establishment procedure or an RRC connection reconfiguration procedure for a transition to an RRC connected mode. The RRC connection establishment procedure may be performed when the BS performs paging to the terminal in the idle mode or when the MS in the idle mode performs a call establishment procedure. Hereinafter, the method of transmitting information regarding PC by the MS in the idle mode by using the RRC connection establishment procedure will be described. The transmission of information regarding PC is also called a power coordination report (PCR).

FIG. 11 is a flow chart illustrating a process of a method for transmitting information regarding power coordination in a multi-component carrier system according to an embodiment of the present invention.

With reference to FIG. 11, the MS transmits information regarding PC to the BS (S1100). As mentioned above, the information regarding PC may be a PC table, an index indicating a particular PC table, or an aggregation of various information elements used for specifying a PC table. The information regarding PC may be transmitted through an RRC message or a MAC message.

The BS performs uplink scheduling with reference to the PC table determined based on the information regarding PC (S1105). Here, the uplink scheduling may determine a modulation scheme not exceeding the maximum transmission power of the MS based on the range of amount of PC on the PC table referred to and resource blocks to be allocated.

The BS transmits an uplink grant based on the uplink scheduling to the MS (S1110). The uplink grant is downlink control information (DCI) of a format 0 for an uplink resource allocation with respect to the MS, which is transmitted on a PDCCH. The uplink grant may be configured as shown in Table 5 below.

TABLE 5
-Flag for format0/format1A differentiation - 1 bit, where value 0 indicates
format 0 and value 1 indicates format 1A
-Frequency hopping flag - 1 bit
-Resource block assignment and hopping resource allocation -
┌log₂(N_{RB}^{UL}(N_{RB}^{UL} + 1)/2)┐ bits
-For PUSCH hopping:

-N_{UL}_{_{—}}ₕₒₚ MSB bits are used to obtain the value of ñ_{PRB}(i)
- (┌log₂(N_{RB}^{UL}(N_{RB}^{UL} + 1)/2)┐ − N_{UL}_{_{—}}ₕₒₚ) bits provide the

resource allocation of the first slot in the UL subframe

-For non-hopping PUSCH:

```
  - (┌log₂(N_{RB}^{UL}(N_{RB}^{UL} + 1)/2)┐) bits provide the resource allocation
  in the UL subframe
```

-Modulation and coding scheme and redundancy version - 5 bits
-New data indicator -1 bit
-TPC command for scheduled PUSCH -2 bits
-Cyclic shift for DM RS - 3 bits
-UL index - 2 bits (this field is present only for TDD operation with
uplink-downlink configuration 0)

| | |
|---|---|
| - | Downlink Assignment Index (DAI) -2 bits (this field is present |

only for TDD operation with uplink-downlink configurations 1-6)
-CQI request -1 bit
-Carrier Index Field (CIF) -3 bits(this field is present only for Carrier
Aggregation)

With reference to Table 5, the uplink grant includes information regarding RB, modulation and coding scheme (MCS), TPC, and the like.

The MS transmits uplink data generated based on the number of RBs, MCS, TPC, and the like, included in the uplink grant to the BS (S1115).

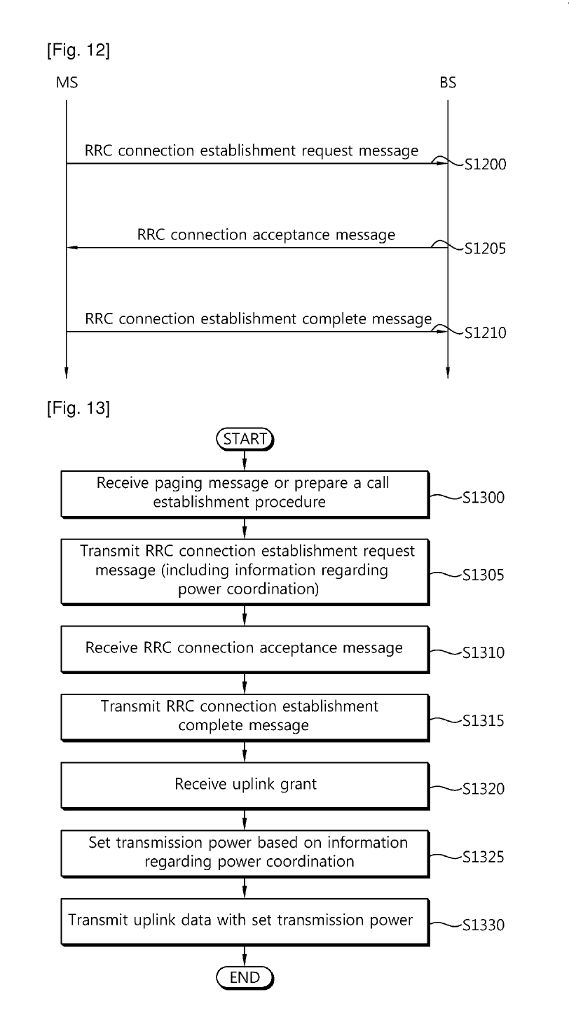

FIG. 12 is a flow chart illustrating a process of a method for transmitting information regarding power coordination in a multi-component carrier system according to another embodiment of the present invention.

With reference to FIG. 12, the MS transmits an RRC connection establishment request message including information regarding power coordination (PC) to the BS (S1200).

The RRC connection establishment request message is generated by an RRC layer of the MS. As mentioned above, the information regarding PC included in the RRC connection establishment request message may be a PC table, an index indicating a PC table, or an aggregation of various information elements used for specifying a PC table.

Here, the PC table is configured by the combination of at least two among the number of aggregatable CCs, the number of available RFs, a modulation scheme, an allocated frequency bandwidth, and the amount of resource blocks. Also, the PC table may be configured by the combination of parameters, e.g., power class and the number of supportable transmission RFs, exhibiting hardware characteristics regarding PC.

The BS transmits an RRC connection acceptance message to the MS in response to the RRC connection establishment request message (S1205).

Upon receiving the RRC connection acceptance message, the MS transmits an RRC connection establishment complete message to the BS (S1210), thus completing the RRC connection establishment procedure.

Here, it has been described that the information regarding PC is included in the RRC connection establishment request message, but the information regarding PC may also be included in a different RRC message, e.g., the RRC connection establishment complete message, transmitted from the MS to the BS. Alternatively, the information regarding PC may be divided to be transmitted in the RRC connection establishment request message and in the RRC connection establishment complete message.

In this manner, the information regarding PC can be transmitted by making use of the RRC connection establishment procedure, and accordingly, a RRC-related message newly has a structure including the information regarding PC.

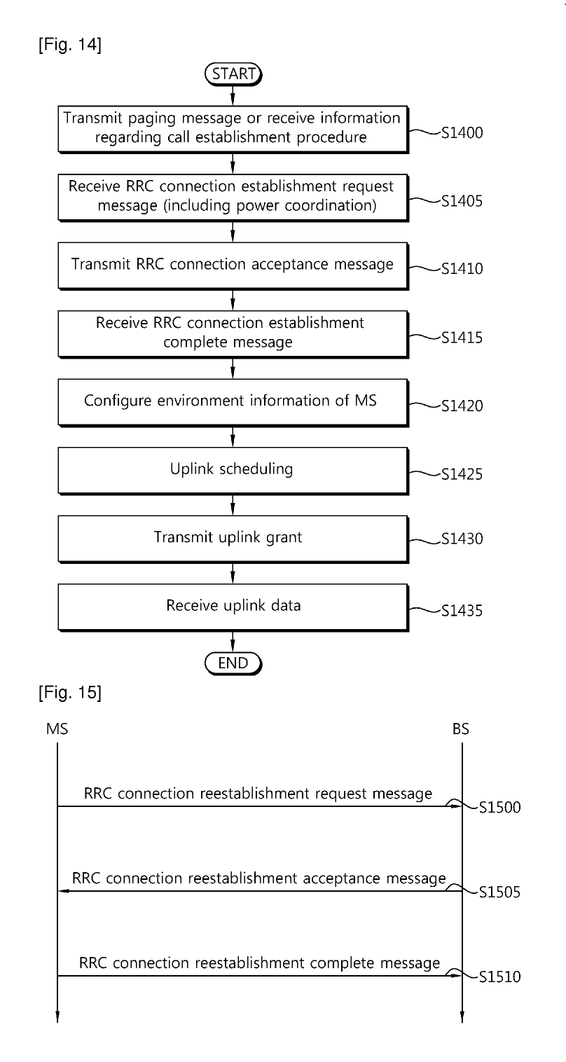

Hereinafter, the operation of the MS and the BS performing the RRC connection establishment procedure to transmit or receive the information regarding PC will now be described with reference to FIGS. 13 and 14.

FIG. 13 is a flow chart illustrating a process of a method for transmitting information regarding power coordination by the MS in a multi-component carrier system according to an embodiment of the present invention.

With reference to FIG. 13, the configuration of an RRC connection establishment request message is triggered by the MS. For example, when the MS receives a paging message or when a call establishment is required by the MS, the RRC connection establishment request is triggered (S1300).

The MS configures an RRC connection establishment request message including information regarding PC and transmits the same to the BS (S1305).

As mentioned above, the information regarding PC (e.g., MPR) may be a PC table, an index indicating a PC table, or an aggregation of various information elements used for specifying a PC table. Here, the PC table may be configured by the combination of at least two among the number of aggregatable CCs, the number of available RFs, a modulation scheme, an allocated frequency bandwidth, and the amount of resource blocks. Also, the PC table may be configured by the combination of parameters, e.g., power class and the number of supportable transmission RFs, exhibiting hardware characteristics regarding PC.

Thereafter, the MS receives an RRC connection acceptance message from the BS in response to the RRC connection establishment request message (S1310).

The MS transmits an RRC connection establishment complete message to the BS in response to the RRC connection acceptance message (S1315).

Since the RRC connection establishment between the BS and the MS is completed, the MS enters the RRC connection mode and is in a state in which it can transmit and receive data. The MS receives an uplink grant, scheduling information required for transmitting uplink data to the BS, from the BS (S1320). The uplink grant provides power information required for transmitting uplink data, resource allocation information, modulation and coding scheme, or the like, to the MS. The MS sets transmission power of the uplink data based on the information regarding PC (S1325).

The MS transmits the uplink data processed according to the uplink grant, to the BS based on the set transmission power (S1330).

FIG. 14 is a flow chart illustrating a process of a method for receiving information regarding power coordination by a BS in a multi-component carrier system according to an embodiment of the present invention.

With reference to FIG. 14, the BS may transmit a paging message to the MS or receive information regarding a call establishment procedure by the MS (S1400). The MS is in the idle mode, and the paging message is transmitted in order to change the MS in the idle mode into an RRC connection mode.

The BS receives an RRC connection establishment request message from the MS in response to the paging message or as part of a call establishment procedure (S1405).

Here, the RRC connection establishment request message includes information regarding PC, and the information regarding PC may be a PC table, an index indicating a PC table, or an aggregation of various information elements used for specifying a PC table.

Here, the PC table is configured by the combination of at least two among the number of aggregatable CCs, the number of available RFs, a modulation scheme, an allocated frequency bandwidth, and the amount of resource blocks. Also, the PC table may be configured by the combination of parameters, e.g., power class and the number of supportable transmission RFs, exhibiting hardware characteristics regarding PC. The BS transmits an RRC connection acceptance message to the MS in response to the RRC connection establishment request message (S1410). The RRC connection acceptance message may include information regarding CC to be set in the MS.

Thereafter, the BS receives an RRC connection establishment complete message from the MS (S1415). The BS configures MS context including the information regarding PC (S1420). The MS context is stored in the BS (eNB) or RNC (Radio Network Controller), SGSN (Serving GPRS Supporting Node), GGSN (Gateway GPRS Support Node), or the like, and managed. The BS performs scheduling on the MS based on the information regarding PC (S1425). Here, the scheduling refers to uplink scheduling, and the BS transmits an uplink grant, the results of scheduling, to the MS (S1430). The BS receives uplink data processed by the MS according to the uplink grant, from the MS (S1435).

FIG. 15 is a flow chart illustrating a process of a method for transmitting information regarding power coordination in a multi-component carrier system according to another embodiment of the present invention.

FIG. 15 is different from FIG. 12 in that information regarding PC is transmitted or received as part of a RRC connection reestablishment procedure.

With reference to FIG. 15, the MS transmits an RRC connection reestablishment request message to the BS (S1500). Here, the RRC connection reestablishment request message is a message of an RRC layer level transmitted by the MS to the BS in order to recover the RRC connection establishment when a situation such as a radio link failure (RLF), or the like, takes place. A recovery procedure of the existing RRC connection establishment is performed according to the RRC connection reestablishment request message.

Meanwhile, the RRC connection reestablishment request message includes information regarding PC, and the information regarding PC may be a PC table, an index indicating a PC table, or an aggregation of various information elements used for specifying a PC table. Here, the PC table is configured by the combination of at least two among the number of aggregatable CCs, the number of available RFs, a modulation scheme, an allocated frequency bandwidth, and the amount of resource blocks. Also, the PC table may be configured by the combination of parameters, e.g., power class and the number of supportable transmission RFs, exhibiting hardware characteristics regarding PC.

The BS transmits an RRC connection reestablishment acceptance message to the MS in response to the RRC connection reestablishment request message (S1505).

The MS transmits an RRC connection reestablishment complete message to the BS in response to the RRC connection reestablishment acceptance message (S1510).

Here, it has been described that the information regarding PC is included in the RRC connection reestablishment request message, but the information regarding PC may also be included in a different RRC message, e.g., the RRC connection reestablishment complete message, transmitted from the MS to the BS. Alternatively, the information regarding PC may be divided to be transmitted in the RRC connection reestablishment request message and in the RRC connection reestablishment complete message.

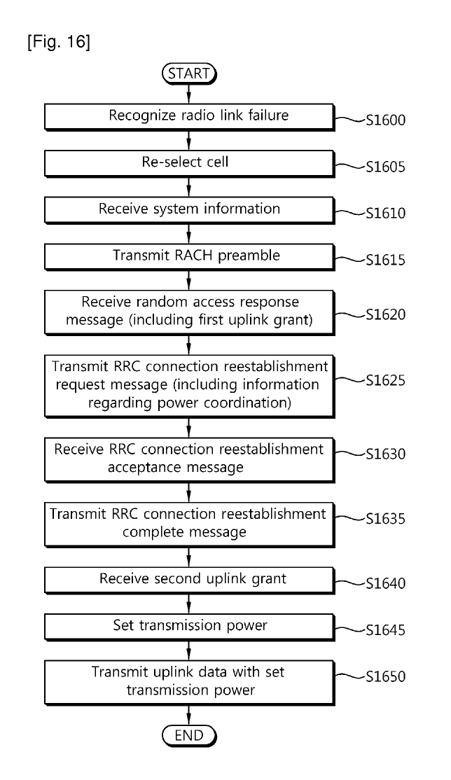

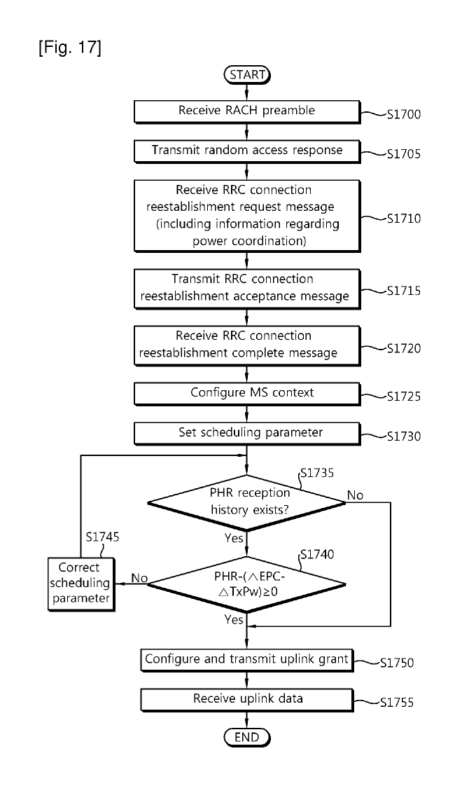

Hereinafter, the operation of the MS and the BS performing the RRC connection reestablishment procedure for transmitting or receiving the information regarding PC will be described with reference to FIGS. 16 and 17.

FIG. 16 is a flow chart illustrating a process of a method for transmitting information regarding power coordination by the MS in a multi-component carrier system according to another embodiment of the present invention.

With reference to FIG. 16, the MS recognizes a radio link failure (S1600). When the MS is in the RRC connection mode, the MS and the BS are in a state in which a radio link is connected. However, when a channel state deteriorates, out-of-synchronization of the radio link may occur in the physical layer of the MS. When the out-of-synchronization continuously occurs by more than a certain number of times, the MS recognizes the radio link failure. Upon recognizing the radio link failure, the MS performs a procedure of reselecting a cell with good quality, and reselects a cell (S1605).

The MS receives new system information (SI) from the reselected cell (S1610).

In order to obtain resources required for performing the RRC connection reestablishment procedure, the MS enters a random access procedure, and at this time, the MS transmits a random access channel (RACH) preamble to the BS (S1615). The RACH preamble is transmitted via a physical channel called RACH.

The MS receives a random access response (RAR) message from the BS in response to the RACH preamble (S1620). The RAR message includes a first uplink grant informing about uplink resource required for uplink transmission of the MS. The first uplink grant provides resource for transmission of the RRC connection reestablishment request message.

The MS transmits the RRC connection reestablishment request message to the BS (S1625). Here, the RRC connection reestablishment request message includes information regarding PC, and the information regarding PC may be a PC table, an index indicating a PC table, or an aggregation of various information elements used for specifying a PC table.

In response to the RRC connection reestablishment request message, the MS receives an RRC connection reestablishment acceptance message from the BS (S1630) and is transmits an RRC connection reestablishment complete message to the BS (S1635).

Since the MS is recovered from the radio link failure and the wireless connection is reestablished, the MS receives a second uplink grant from the BS (S1640). Here, the second uplink grant provides scheduling regarding transmission of uplink data of the MS.

The MS sets transmission power based on the information regarding PC (S1645) and transmits the uplink data with the set transmission power to the BS (S1650). The uplink data is data which has been processed by MCS, TPC, and the like, included in the uplink grant.

FIG. 17 is a flow chart illustrating a process of a method for receiving information regarding power coordination by the BS in a multi-component carrier system according to another embodiment of the present invention.

With reference to FIG. 17, the BS receives an RACH preamble from the MS (S1700).

The BS transmits a random access response (RAR) message to the MS in response to the RACH preamble (S1705). The RAR message includes a first uplink grant informing about uplink resource required for uplink transmission of the MS. The first uplink grant provides resource to be used for the MS to transmit an RRC connection reestablishment request message.

The BS receives an RRC connection reestablishment request message from the MS (S1710). Here, the RRC connection reestablishment request message includes information regarding PC, and the information regarding PC may be a PC table, an index indicating a PC table, or an aggregation of various information elements used for specifying a PC table.

In response to the RRC connection reestablishment request message, the BS transmits an RRC connection reestablishment acceptance message to the MS (S1715) and is receives an RRC connection reestablishment complete message from the MS (S1720). The BS configures MS context including the information regarding PC (S1725).

The BS sets scheduling parameters such as MCS, TPC, resource allocation information, and the like, in consideration of a buffer state report (BSR), a network situation, a resource usage situation, and the like, received to uplink (S1730).

The BS determines whether or not history (or a record) exists that it has received power head report (PHR) (S1735). Here, a PH value by the PHR is the last PH value which has been most recently received. Whether or not there is history that the BS has received PHR can be known through the MS context.

When there is no history that the BS has received PHR, the BS does not consider a parameter related to scheduling such as the PHR, or the like, in configuring an uplink grant including a new data indicator (NDI) which is first transmitted. Thus, the BS configures the uplink grant based on the set scheduling parameter, and transmits the same to the MS (S1750).

When there is history that the BS has received PHR, the BS determines scheduling validity (S1740). Here, determination of scheduling validity refers to determining, by the BS, whether or not a changed scheduling parameter is valid in terms of uplink maximum transmission power based on the PHR last received by the BS when the scheduling parameter, which affects an estimated power coordination value, is changed.

An example of determination of scheduling validity is as shown in Math figure 8 below.

PHR−(ΔEPC−ΔTxPw)≧0 [Math figure 8]

With reference to Math figure 8, ΔEPC is a value obtained by subtracting an is estimated power coordination (EPC) value estimated based on a previous scheduling parameter from an EPC value estimated based on a current scheduling parameter. The scheduling parameters affecting the EPC value include the number of resource blocks, a modulation scheme, a PUSCH resource allocation form (whether or not resource is allocated continuously or discontinuously), whether or not the PUCCH exists (whether or not PUCCH and PUSCH are transmitted in parallel or whether or not PUSCH is transmitted alone), and the like.

Meanwhile, ΔTxPw=ΔPUSCH+ΔPUCCH. Here, ΔPUCCH is considered only in case of a major cell. ΔPUSCH is a value obtained by subtracting power of the last scheduled PUSCH from power of PUSCH calculated according to a current scheduling parameter. Δ PUCCH is a value obtained by subtracting power of the last received PUCCH from power of PUCCH to be received through major cells in a corresponding sub-frame. Here, since the PUCCH is received through major cells of the MS according to a period set for each MS by the BS, the BS can estimate whether or not the PUCCH has been received according to subframes.

When the determination of scheduling validity is made by Math figure 8, if Math FIG. 8 is false, the scheduling parameter is corrected such that ΔEPC or ΔTxPw is reduced according to the policy of the corresponding BS (S1745).

If Math figure 8 is true, since the set scheduling parameter is valid, the BS configures an uplink grant based on the set scheduling parameter and transmits the configured uplink grant to the MS (S1750). Thereafter, the BS receives uplink data from the MS (S1755).

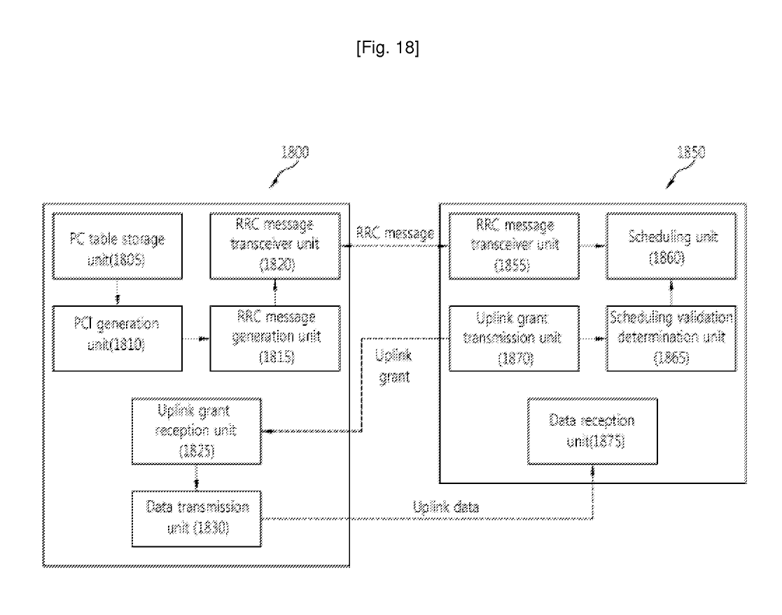

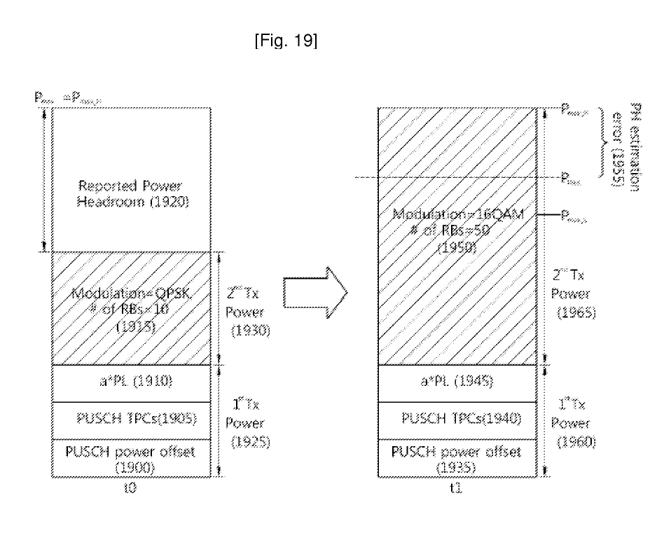

FIG. 18 is a schematic block diagram showing an apparatus for transmitting information regarding power coordination and an apparatus for receiving information regarding power coordination in a multi-component carrier system according to an embodiment of the present invention.

With reference to FIG. 18, an apparatus 1800 for transmitting information regarding power configuration (will be referred to as a ‘power coordination information (PCI) transmission apparatus, hereinafter) includes a PC table storage unit 1805, a PCI generation unit 1810, an RRC message generation unit 1815, an RRC message transceiver unit 1820, an uplink (UL) grant reception unit 1825, and a data transmission unit 1830. The PCI transmitter may be part of the MS.

The PC table storage unit 1805 stores a PC table. Table 6 below shows an example of a PC table.

TABLE 6

| | | Channel bandwidth/ | | | | | | |
|---|---|---|---|---|---|---|---|---|
| | Modulation | Transmission bandwidth configuration (RB) | | | | | | PC (dB) |
| | Modulation | 1.4 MHz | 2.5 MHz | 5 MHz | 10 MHz | 15 MHz | 20 MHz | PC (dB) |
| #CCs = 1, | QPSK | >5 | >4 | >8 | >12 | >16 | >18 | ≦1 |
| #RF = 1 | | | | | | | | |
| #CCs = 1, | 16QAM | ≦5 | ≦4 | ≦8 | ≦12 | ≦16 | ≦18 | ≦1 |
| #RF = 1 | | | | | | | | |
| #CCs = 1, | 16QAM | >5 | >4 | >8 | >12 | >16 | >18 | ≦2 |
| #RF = 1 | | | | | | | | |
| #CCs = 2, | QPSK, QPSK | >5, >5 | >4, >4 | >8, >8 | >12, >12 | >16, >16 | >18, >18 | 3 ≦ x ≦ 4 |
| #RF = 1 | | | | | | | | |
| #CCs = 2, | QPSK, 16QAM | >5, ≦5 | >4, ≦4 | >8, ≦8 | >12, ≦12 | >16, ≦16 | >18, ≦18 | 3 ≦ x ≦ 4 |
| #RF = 1 | | | | | | | | |
| #CCs = 2, | QPSK, 16QAM | >5, >5 | >4, >4 | >8, >8 | >12, >12 | >16, >16 | >18, >18 | 5 ≦ x ≦ 6 |
| #RF = 1 | | | | | | | | |
| #CCs = 2, | 16QAMx2 | ≦5, ≦5 | ≦4, ≦4 | ≦8, ≦8 | ≦12, ≦12 | ≦16, ≦16 | ≦18, ≦18 | 3 ≦ x ≦ 4 |
| #RF = 1 | | | | | | | | |
| #CCs = 2, | 16QAMx2 | >5, ≦5 | >4, ≦4 | >8, ≦8 | >12, ≦12 | >16, ≦16 | >18, ≦18 | 5 ≦ x ≦ 6 |
| #RF = 1 | | | | | | | | |
| #CCs = 2, | 16QAMx2 | >5, >5 | >4, >4 | >8, >8 | >12, >12 | >16, >16 | >18, >18 | 8 ≦ x ≦ 10 |
| #RF = 1 | | | | | | | | |
| #CCs = 2, | QPSK, QPSK | >5, >5 | >4, >4 | >8, >8 | >12, >12 | >16, >16 | >18, >18 | ≦2 |
| #RF = 2 | | | | | | | | |
| #CCs = 2, | QPSK, 16QAM | >5, ≦5 | >4, ≦4 | >8, ≦8 | >12, ≦12 | >16, ≦16 | >18, ≦18 | 3 ≦ x ≦ 5 |
| #RF = 2 | | | | | | | | |
| #CCs = 2, | QPSK, 16QAM | >5, >5 | >4, >4 | >8, >8 | >12, >12 | >16, >16 | >18, >18 | 5 ≦ x ≦ 7 |
| #RF = 2 | | | | | | | | |
| #CCs = 2, | 16QAMx2 | ≦5, ≦5 | ≦4, ≦4 | ≦8, ≦8 | ≦12, ≦12 | ≦16, ≦16 | ≦18, ≦18 | 5 ≦ x ≦7 |
| #RF = 2 | | | | | | | | |
| #CCs = 2, | 16QAMx2 | >5, ≦5 | >4, ≦4 | >8, ≦8 | >12, ≦12 | >16, ≦16 | >18, ≦18 | 7 ≦ x ≦ 9 |
| #RF = 2 | | | | | | | | |
| #CCs = 2, | 16QAMx2 | >5, >5 | >4, >4 | >8, >8 | >12, >12 | >16, >16 | >18, >18 | 9 ≦ x ≦ 11 |
| #RF = 2 | | | | | | | | |

. . .
. . .
. . .
. . .

| | | | | | | | | |
|---|---|---|---|---|---|---|---|---|
| #CCs = 5, | QPSK, QPSK, | >5, >5, >5, | >4, >4, | >8, >8, | >12, >12, | >16, >16, | >18, >18, | ≦2 |
| #RF = 2 | QPSK, QPSK, | >5, >5 | >4, >4, | >8, >8, | >12, >12, | >16, >16, | >18, >18, | |
| | QPSK | | >4 | >8 | >12 | >16 | >18 | |
| #CCs = 5, | QPSK, QPSK, | >5, >5, >5, | >4, >4, | >8, >8, | >12, >12, | >16, >16, | >18, >18, | 2 ≦ x ≦ 4 |
| #RF = 2 | QPSK, QPSK, | >5, ≦5 | >4, >4, | >8, >8, | >12, >12, | >16, >16, | >18, >18, | |
| | 16QAM | | ≦4 | ≦8 | ≦12 | ≦16 | ≦18 | |
| #CCs = 5, | . | . | . | . | . | . | . | . |
| #RF = 2 | . | . | . | . | . | . | . | . |
| | . | . | . | . | . | . | . | . |
| #CCs = 5, | 16QAM | >5, >5, >5, | >4, >4, | >8, >8, | >12, >12, | >16, >16, | >18, >18, | 10 ≦ x ≦ 12 |
| #RF = 2 | | >5, >5 | >4, >4, | >8, >8, | >12, >12, | >16, >16, | >18, >18, | |
| | | | >4 | >8 | >12 | >16 | >18 | |

This is an example of a PC table, so there may be various PC tables through various combinations.

The PCI generation unit 1810 generates information regarding PC. The information regarding PC may be information providing an amount or a range of PC specified according to various communication environments to the BS.

For example, the information regarding PC may be a table itself as shown in Table 6. Table 7 below shows an example of configuring the information regarding PC, as an index.

TABLE 7

| Index | 1 | 2 | . . . | N − 1 | N |
|---|---|---|---|---|---|
| Table | table 1 | table 2 | . . . | table N − 1 | table N |
| Number | | | | | |

In another example, the information regarding PC may be configured in the form of an aggregation of various information elements. The information element is a parameter indicating hardware characteristics regarding PC, which includes a power class, the number of supportable transmission and reception RFs, and the number of aggregatable CCs of the MS. A PC table may be specified by a combination of information elements. For example, information regarding PC may be defined as shown in Table 8 below.

TABLE 8
Information regarding PC

| | |
|---|---|
| Powerclass | 3 |
| RF | 2 |
| Aggregatable CC | 5 |

The RRC message generation unit 1815 generates an RRC message including information regarding PC. For example, the RRC message generation unit 1815 generates an RRC connection establishment request message including information regarding PC, an RRC connection reestablishment request message including information regarding PC, an RRC connection establishment complete message including information regarding PC, and an RRC connection reestablishment complete message including information regarding PC. The RRC message including information regarding PC may additionally include information regarding PC, as well as content of the original RRC message.

The RRC message transceiver unit 1820 transmits an RRC message including information regarding PC to an apparatus 1850 for receiving information regarding PC (will be referred to as a ‘power coordination information (PCI) reception apparatus 1850’, hereinafter).

The uplink grant reception unit 1825 receives an uplink grant from the PCI reception apparatus 1850 of the information regarding PC. Table 9 shows an example of the uplink grant.

TABLE 9
-Flag for format0/format1A differentiation - 1 bit, where value 0 indicates
format 0 and value 1 indicates format 1A
-Frequency hopping flag - 1 bit
-Resource block assignment and hopping resource allocation -
┌log₂(N_{RB}^{UL}(N_{RB}^{UL} + 1)/2)┐ bits
-For PUSCH hopping:

-N_{UL}_{_{—}}ₕₒₚ MSB bits are used to obtain the value of ñ_{PRB}(i)
- (┌log₂(N_{RB}^{UL}(N_{RB}^{UL} + 1)/2)┐ − N_{UL}_{_{—}}ₕₒₚ) bits provide the

resource allocation of the first slot in the UL subframe

-For non-hopping PUSCH:

- (┌log₂(N_{RB}^{UL}(N_{RB}^{UL} + 1)/2)┐) bits provide the resource

allocation in the UL subframe
-Modulation and coding scheme and redundancy version - 5 bits
-New data indicator -1 bit
-TPC command for scheduled PUSCH -2 bits
-Cyclic shift for DM RS - 3 bits
-UL index - 2 bits (this field is present only for TDD operation with
uplink-downlink configuration 0)

| | |
|---|---|
| - | Downlink Assignment Index (DAI) -2 bits (this field is present |

only for TDD operation with uplink-downlink configurations 1-6)
-CQI request -1 bit
-Carrier Index Field (CIF) -3 bits(this field is present only for Carrier
Aggregation)

The data transmission unit 1830 transmits uplink data based on a scheduling parameter according to the received uplink grant and information regarding PC to the PCI reception apparatus 1850.

The PCI reception apparatus 1850 includes an RRC message transceiver unit 1855, a scheduling unit 1860, a scheduling validity determination unit 1865, an uplink grant transmission unit 1870, and a data reception unit 1875. The PCI reception apparatus 1850 may be part of the BS.

The RRC message transceiver unit 1855 transmits an RRC message including information regarding PC to the PCI transmission apparatus 1800 or receives an RRC message including information regarding PC from the PCI transmission apparatus 1800.

The scheduling unit 1860 sets scheduling parameters such as MCS, TPC, resource allocation information, and the like, with respect to the PCI transmission apparatus 1800 in consideration of a channel situation, a buffer state report, a network situation, a resource usage situation, and the like, of the PCI transmission apparatus 1800.

When a scheduling parameter affecting estimated power coordination value is changed by the scheduling unit 1860, the scheduling validity determination unit 1865 determines whether or not the changed scheduling parameter is valid in terms of uplink maximum transmission power based on the PHR finally received by the PCI reception apparatus 1850. An example of determination of scheduling validity is performed by Math figure 8 shown above.

The uplink grant transmission unit 1870 configures an uplink grant based on the scheduling parameter determined to be valid according to the determination results of scheduling validity, and transmits the configured uplink grant to the PCI information transmission apparatus 1800.

The data reception unit 1875 receives uplink data from the PCI information transmission apparatus 1800.

FIG. 19 is a conceptual view showing the influence of uplink scheduling of the BS on transmission power of the MS in a wireless communication system.

With reference to FIG. 19, the MS receives an uplink grant allowing uplink data transmission from the BS at time (or subframe) t0 through a PDCCH. Thus, the terminal should calculate an amount of transmission power according to the uplink grant at t0.

First, at time t0, the MS calculates first transmission power 1925 in consideration of a PUSCH power offset value 1900 and a transmission power control (TPC) value 1905 received from the BS and an ‘a’ value (received from the BS), a weight, to a path loss (PL) 1910 between the BS and the MS. The first transmission power (1st Tx Power) 1925 is largely according to a parameter affected by a path environment between the BS and the MS and a parameter determined by a policy of a network. In addition, the MS calculates a second transmission power (2nd Tx Power) 1930 in consideration of a scheduling parameter 1915 indicating a QPSK modulation scheme and an allocation of ten resource blocks (RBs). The second transmission power 1930 is transmission power changing through uplink scheduling of the BS.

Thus, the MS can calculate final uplink transmission power by adding the first transmission power 1925 and the second transmission power 1930. Here, the final uplink transmission power cannot exceed the set maximum transmission power (Pₘₐₓ) of the MS. In the example of FIG. 19, since the final transmission power is smaller than Pmax value at the time t0, so the uplink information according to a set parameter can be transmitted. Also, there is power headroom (PH) 1920, an extra with respect to transmission power, which can be additionally set. The PH 1920 is transmitted by the MS to the BS according to a rule defined in the wireless communication system.

At time t1, the BS changes into a scheduling parameter 1950 indicating a 16QAM modulation scheme and allocation of 50 resource blocks in consideration of transmission power which can be additionally set for the MS through information of PH 1920. The MS resets second transmission power 1965 according to the scheduling parameter 1950. A first transmission power 1960 at time t1 is determined in consideration of a PUSCH power offset value 1935, a TPC value 1940, and an ‘a’ value (received from the BS), a weight, to a PL 1945 between the BS and the MS, and here, it is assumed that the first transmission power 1960 is equal to the first transmission power 1925 at time t0.

At time t1, Pₘₐₓ is changed into a value close to Pₘₐₓ_{_{—}}_{L}, while the sum of the second transmission power 1965 and the first transmission power 1960 requested by the scheduling parameter 1950 exceeds Pₘₐₓ. Namely, a PH estimated value error 1955 by Pₘₐₓ_{_{—}}_{H}-Pₘₐₓ occurs. In this manner, when scheduling is performed on the uplink resource based only on PH information, the MS cannot set uplink transmission power expected by the BS, generating performance degradation. When the CC aggregation scheme is used, the PH estimated value error 1955 is further increased. Thus, power coordination is required for reducing the set maximum transmission power in the MS.

4. Structure of Message for Power Coordination Report (PCR).

Information regarding PC is a MAC message generated in a MAC layer. Thus, the MS performs PCR by using uplink resource allocated by the uplink grant as shown in Table 10 below.

TABLE 10
-Flag for format0/format1A differentiation - 1 bit, where value 0 indicates
format 0 and value 1 indicates format 1A
-Frequency hopping flag - 1 bit
-Resource block assignment and hopping resource allocation -
┌log₂(N_{RB}^{UL}(N_{RB}^{UL} + 1)/2)┐ bits
-For PUSCH hopping:

-N_{UL}_{_{—}}ₕₒₚ MSB bits are used to obtain the value of ñ_{PRB}(i)
- (┌log₂(N_{RB}^{UL}(N_{RB}^{UL} + 1)/2)┐ − N_{UL}_{_{—}}ₕₒₚ) bits provide the

resource allocation of the first slot in the UL subframe

-For non-hopping PUSCH:

- (┌log₂(N_{RB}^{UL}(N_{RB}^{UL} + 1)/2)┐) bits provide the resource

allocation in the UL subframe
-Modulation and coding scheme and redundancy version - 5 bits
-New data indicator -1 bit
-TPC command for scheduled PUSCH -2 bits
-Cyclic shift for DM RS - 3 bits
-UL index - 2 bits (this field is present only for TDD operation with
uplink-downlink configuration 0)

| | |
|---|---|
| - | Downlink Assignment Index (DAI) -2 bits (this field is present |

only for TDD operation with uplink-downlink configurations 1-6)
-CQI request -1 bit
-Carrier Index Field (CIF) -3 bits(this field is present only for Carrier
Aggregation)

With reference to FIG. Table 10, the uplink grant is information corresponding to format 0 of downlink control information transmitted on a PDCCH, which includes information such as RB, a modulation and coding scheme (MCS), a TPC, and the like.

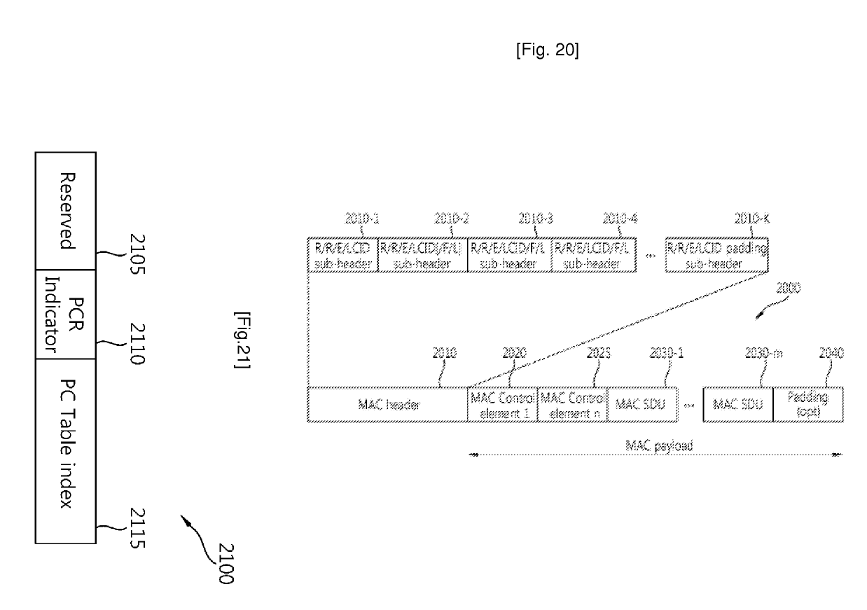

FIG. 20 is a block diagram showing the structure of a MAC PDU (protocol data unit) for a power coordination report (PCR) according to an embodiment of the present invention. A MAC PDU is also called a transport block (TB).

With reference to FIG. 20, a MAC PDU 2000 includes a MAC header 2010, one or more MAC control elements 2020, . . . , 2025, one or more MAC SDUs (Service Data Unit) 2030-1, . . . , 2030-m, and a padding 2040.

The MAC control elements 2020 and 2025 are control messages generated by the MAC layer.

The MAC SDUs 2030-1, . . . , 2030-m are the same as RLC (Radio Link Control) PDUs transferred from an RLC layer. The padding 2040 is a certain number of bits added to make the size of the MAC PDU uniform. The unity of the MAC control elements 2020, . . . , 2025, the MAC SDUs 2030-1, . . . , 2030-m, and the padding 2040 is called MAC payload.

The MAC header 2010 includes one or more subheaders 2010-1, 2010-2, . . . , 2010-k, and each of the subheaders 2010-1, 2010-2, . . . , 2010-k corresponds to one MAC SDU, one MAC control element, or the padding. The subheaders 2010-1, 2010-2, . . . , 2010-k are disposed in the same order as that of the MAC SDUs, the MAC control elements, or the paddings.

Each of the subheaders 2010-1, 2010-2, . . . , 2010-k includes four fields of R, R, E, and LCID, or six fields of R, R, E, LCID, F, and L. The subheader including four fields is a subheader corresponding to the MAC control element or the padding, and the subheader including the six fields is a subheader corresponding to the MAC SDU.

The logical channel ID (LCID) field is an identifying field for identifying a logical channel corresponding to the MAC SDU or identifying the type of the MAC control element or the padding, and it may have 5 bits.

For example, the LCID field identifies whether a corresponding MAC control element is a PH MAC control element for transmission of PH, whether it is a feedback request MAC control element requesting feedback information from the MS, whether it is a discontinuous reception command MAC control element regarding a discontinuous reception command, or whether it is a contention resolution identity MAC control element for resolving contention between MSs.

Also, according to an embodiment of the present invention, the LCID field can identify whether or not a corresponding MAC control element is a PCR (Power Coordination Report) MAC control element for a PCR. There is one LCID field with respect to each of the MAC SDU, the MAC control element, or the padding. Table shows an example of the LCID field.

TABLE 11

| Index | LCID values |
|---|---|
| 00000 | CCCH |
| 00001-01010 | Identity of the logical channel |
| 01011-11000 | Reserved |
| 10110 | Power Coordination Report |
| 10111 | UL activation/deactivation |
| 11000 | DL activation/deactivation |
| 11001 | Reference CC Indicator |
| 11010 | Power Headroom Report |
| 11011 | C-RNTI |
| 11100 | Truncated BSR |
| 11101 | Short BSR |
| 11110 | Long BSR |
| 11111 | Padding |

With reference to Table 11, the LCID field value 10110 indicates that a corresponding MAC control element is the PCR MAC control element according to an embodiment of the present invention.

FIG. 21 is a block diagram showing the structure of a MAC PDU for a power coordination report according to another embodiment of the present invention.

With reference to FIG. 21, a PCR field 2100 in the payload of the MAC PDU includes reserved (bits) 2105, PCR indicator 2110, and a PC table index 2115. The payload may be a PCR MAC control element or a MAC SDU.

The PCR field 2100 is a field in the MAC PDU including information regarding PC. When information regarding PC corresponds to content, the PCR field 2100 corresponds to a structure carrying the information regarding PC.

The reserved 2105 and the PCR indicator 2110 may be comprised of one bit, and the PC table index 2115 may be comprised of 6 bits.

For example, the PCR indicator 2110, comprised of 1 bit, indicates whether corresponding payload is an MS-specific PCR field 2100 or a CC-specific PCR field 2100. For example, when the PCR indicator 2110 is 0, it indicates that the corresponding payload is an MS-specific PCR field 2100, and when the PCR indicator 2110 is 1, it indicates that the corresponding payload is CC-specific PCR field 2100. The CC-specific power coordination refers to that a power coordination amount is determined for each CC by the MS when a frequency band defined by CC is considered.

In another example, when RF power coordination is defined in the wireless communication system, the PCR indicator 2100 indicates whether or not corresponding payload is an MS-specific PCR field 2100 or whether or not corresponding payload is an RF-unit PCR field 2100 by using 1 bit. For example, when the PCR indicator 2110 is 0, it indicates that the corresponding payload is an MS-specific PCR field 2100, and when the PCR indicator 2110 is 1, it indicates that the corresponding payload is an RF-unit PCR field 2100. The RF-unit PC refers to that a power coordination amount is determined for each RF by the MS when a supportable frequency band in each RF is considered.

When the PC table is defined irrespective of the number of CCs or RFs, the PCR indicator 2110 is reserved.

The PC table index is an index indicating a PC table. The PC table is a table indicating the amount or range of PC required for the MS by communication environment. A communication environment is formed by at least one of a scheduling parameter with respect to the MS, the number of CCs configured in the MS, and the number of RFs supported for the MS. Table 12 below shows an example of a PC table.

TABLE 12

| | | Channel bandwidth/ | | | | | | |
|---|---|---|---|---|---|---|---|---|
| | Modulation | Transmission bandwidth configuration (RB) | | | | | | PC (dB) |
| | Modulation | 1.4 MHz | 2.5 MHz | 5 MHz | 10 MHz | 15 MHz | 20 MHz | PC (dB) |
| #CCs = 1, | QPSK | >5 | >4 | >8 | >12 | >16 | >18 | ≦1 |
| #RF = 1 | | | | | | | | |
| #CCs = 1, | 16QAM | ≦5 | ≦4 | ≦8 | ≦12 | ≦16 | ≦18 | ≦1 |
| #RF = 1 | | | | | | | | |
| #CCs = 1, | 16QAM | >5 | >4 | >8 | >12 | >16 | >18 | ≦2 |
| #RF = 1 | | | | | | | | |
| #CCs = 2, | QPSK, QPSK | >5, >5 | >4, >4 | >8, >8, | >12, >12 | >16, >16 | >18, >18 | 3 ≦ x ≦ 4 |
| #RF = 1 | | | | | | | | |
| #CCs = 2, | QPSK, 16QAM | >5, ≦5 | >4, ≦4 | >8, ≦8 | >12, ≦12 | >16, ≦16 | >18, ≦18 | 3 ≦ x ≦ 4 |
| #RF = 1 | | | | | | | | |
| #CCs = 2, | QPSK, 16QAM | >5, >5 | >4, >4 | >8, >8 | >12, >12 | >16, >16 | >18, >18 | 5 ≦ x ≦ 6 |
| #RF = 1 | | | | | | | | |
| #CCs = 2, | 16QAMx2 | ≦5, ≦5 | ≦4, ≦4 | ≦8, ≦8 | ≦12, ≦12 | ≦16, ≦16 | ≦18, ≦18 | 3 ≦ x ≦ 4 |
| #RF = 1 | | | | | | | | |
| #CCs = 2, | 16QAMx2 | >5, ≦5 | >4, ≦4 | >8, ≦8 | >12, ≦12 | >16, ≦16 | >18, ≦18 | 5 ≦ x ≦ 6 |
| #RF = 1 | | | | | | | | |
| #CCs = 2, | 16QAMx2 | >5, >5 | >4, >4 | >8, >8 | >12, >12 | >16, >16 | >18, >18 | 8 ≦ x ≦ 10 |
| #RF = 1 | | | | | | | | |
| #CCs = 2, | QPSK, QPSK | >5, >5 | >4, >4 | >8, >8 | >12, >12 | >16, >16 | >18, >18 | ≦2 |
| #RF = 2 | | | | | | | | |
| #CCs = 2, | QPSK, 16QAM | >5, ≦5 | >4, ≦4 | >8, ≦8 | >12, ≦12 | >16, ≦16 | >18, ≦18 | 3 ≦ x ≦ 5 |
| #RF = 2 | | | | | | | | |
| #CCs = 2, | QPSK, 16QAM | >5, >5 | >4, >4 | >8, >8 | >12, >12 | >16, >16 | >18, >18 | 5 ≦ x ≦ 7 |
| #RF = 2 | | | | | | | | |
| #CCs = 2, | 16QAMx2 | ≦5, ≦5 | ≦4, ≦4 | ≦8, ≦8 | ≦12, ≦12 | ≦16, ≦16 | ≦18, ≦18 | 5 ≦ x ≦7 |
| #RF = 2 | | | | | | | | |
| #CCs = 2, | 16QAMx2 | >5, ≦5 | >4, ≦4 | >8, ≦8 | >12, ≦12 | >16, ≦16 | >18, ≦18 | 7 ≦ x ≦ 9 |
| #RF = 2 | | | | | | | | |
| #CCs = 2, | 16QAMx2 | >5, >5 | >4, >4 | >8, >8 | >12, >12 | >16, >16 | >18, >18 | 9 ≦ x ≦ 11 |
| #RF = 2 | | | | | | | | |

. . .
. . .
. . .
. . .

| | | | | | | | | |
|---|---|---|---|---|---|---|---|---|
| #CCs = 5, | QPSK, QPSK, | >5, >5, >5, | >4, >4, | >8, >8, | >12, >12, | >16, >16, | >18, >18, | ≦2 |
| #RF = 2 | QPSK, QPSK, | >5, >5 | >4, >4, | >8, >8, | >12, >12, | >16, >16, | >18, >18, | |
| | QPSK | | >4 | >8 | >12 | >16 | >18 | |
| #CCs = 5, | QPSK, QPSK, | >5, >5, >5, | >4, >4, | >8, >8, | >12, >12, | >16, >16, | >18, >18, | 2 ≦ x ≦ 4 |
| #RF = 2 | QPSK, QPSK, | >5, ≦5 | >4, >4, | >8, >8, | >12, >12, | >16, >16, | >18, >18, | |
| | 16QAM | | ≦4 | ≦8 | ≦12 | ≦16 | ≦18 | |
| #CCs = 5, | . | . | . | . | . | . | . | . |
| #RF = 2 | . | . | . | . | . | . | . | . |
| | . | . | . | . | . | . | . | . |
| #CCs = 5, | 16QAMx5 | >5, >5, >5, | >4, >4, | >8, >8, | >12, >12, | >16, >16, | >18, >18, | 10 ≦ x ≦ 12 |
| #RF = 2 | | >5, >5 | >4, >4, | >8, >8, | >12, >12, | >16, >16, | >18, >18, | |
| | | | >4 | >8 | >12 | >16 | >18 | |

With reference to Table 12, #CCs are the number of CCs actually set CCs among the entire aggregatable CCs in the MS, and #RF is the number of actually used RFs among the entire supportable RFs. Table 12 defines the amount or range of PC in a communication environment under various conditions specified by the number of CCs regarding the MS, the number of RFs, modulation, channel bandwidth, and the number of resource blocks (RBs).

It is assumed that a communication environment of #CCs=5 and #RF=2 is set in the MS. If five CCs are modulated by QPSK, QPSK, QPSK, QPSK, and 16QAM, respectively, and 20 RBs are scheduled for each of the five CCs, then, the range of power coordination of the corresponding MS is 2 dB to 4 dB. Thus, the MS can reduce set maximum transmission power by 2 dB to 4 dB.

Table 12 shows an example in which the total number of aggregatable CCs of the MS is 5, power class is 3, and supportable RFs is 2, which are factors for determining a unique specification of the MS. These may be fixedly stored in the MS when the MS was designed.

Thus, a new table may be defined by a new combination of the number of aggregatable CCs, the number of supportable RFs, and power class. Here, since the BS cannot know about the table, the MS transmits a PC table index as shown in Table 13, as information regarding PC to the BS.

TABLE 13

| Index | 1 | 2 | . . . | N − 1 | N |
|---|---|---|---|---|---|
| Table | table 1 | table 2 | . . . | table N − 1 | table N |
| Number | | | | | |

With reference to Table 13, when it is assumed that N number of the PC table as shown in Table 12 is defined in the current system according to the specification of the MS, each of the PC tables is indexed by indexing.

Since the MS only needs to transmit only the index of PC table, as information regarding PC, to the BS, overhead can be considerably reduced compared with the case in which all of the N number of PC tables are transmitted. In this case, the MS and the BS should have the PC tables of all the cases supported in the system and indexes of the respective PC tables stored in a memory. When the number of PC tables is N, N number of indexes indicating all of the N number of PC tables are required. The number of bits which can express all of the N number of indexes is ceiling(log₂(N)). Here, ceiling(x) is a minimum integer greater than x. For example, when 32 tables exist, since ceiling(log₂(32))=6, information regarding PC has 6 bits.

The BS is able to know about the communication environment set in the MS. Thus, when the MS informs the BS about only the PC table index, the BS can indirectly know about the amount or range of PC according to the communication environment. The BS may set a scheduling parameter such that it does not exceed the uplink maximum transmission power of the MS based on the amount or range of PC and the PHR by the MS.

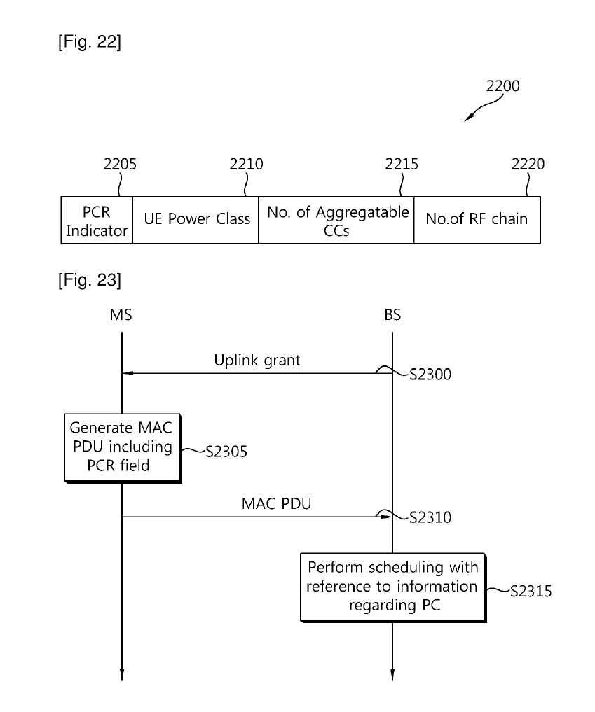

FIG. 22 is a block diagram showing the structure of a MAC PDU for a power coordination report according to another embodiment of the present invention.

With reference to FIG. 22, a PCR field 2200 in the payload of the MAC PDU includes a PCR indicator 2205, a UE power class 2210, No. of aggregatable CCs 2215, and No. of RF chain 2220. The payload may be a PCR MAC control element or a MAC SDU. The PCR indicator field 2205 and the UE power class field 2210 may be comprised of 1 bit, and the fields of No. of aggregatable CCs 2215, and No. of RF chain 2220 may be comprised of 3 bits, respectively.

The UE power class field 2210 refers to class of an MS classified based on maximum transmission power the MS can transmit to uplink. In the example of FIG. 21, only two UE power class fields 2210 are defined. For example, when the UE power class field indicates 0, the MS belongs to power class 3. The power class 3 refers to a class having 23 dBm uplink maximum transmission power. When the UE power class field 2210 indicates 1, the MS belongs to a power class 4. The power class 4 refers to a class having 28 dBm uplink maximum transmission power.

The number of aggregatable CCs has a value of 1 to 5. Thus, when the field of No. of aggregatable CCs 2215 is 000, the number of aggregatable CCs is 1, when it is 001, the number of aggregatable CCs is 12, when it is 010, the number of aggregatable CCs is 3, when it is 011, the number of aggregatable CCs is 4, and when it is 100, the number of aggregatable CCs is 5.

No. of RF chains indicates the number of RF chains configured for the corresponding MS to transmit a signal to uplink and the number of CCs supportable in each RF. No. of RF chains can be expressed as shown in Table 14 below.

TABLE 14

| Bits | RF No. | Number of supportable CCs |
|---|---|---|
| 000 | 1 | Number of aggregatable maximum CCs (MC) |
| 001 | 2 | RF#1 = 1, RF#2 = MC − 1 |
| 010 | 2 | RF#1 = 2, RF#2 = MC − 2 |
| 011 | 2 | RF#1 = 3, RF#2 = MC − 3 |
| 100 | 3 | RF#1 = 1, RF#2 = 1, RF#3 = MC − 2 |
| 101 | 3 | RF#1 = 2, RF#2 = 1, RF#3 = MC − 3 |
| 110 | 3 | RF#1 = 3, RF#2 = 1, RF#3 = MC − 4 |
| 111 | 3 | RF#1 = 2, RF#2 = 2, RF#3 = MC − 4 |

With reference to Table 14, RF#N refers to an RF number, which does not designate particular order but an available configuration.

The UE power class 2210, No. of aggregatable CCs 2215, and No. of RF chain 2220 are parameters exhibiting hardware characteristics regarding PC. A PC table may be specified by the combination of the UE power class 2210, No. of aggregatable CCs 2215, and No. of RF chain 2220. For example, it is assumed that the UE power class 2210, No. of aggregatable CCs 2215, and No. of RF chain 2220 are configured as shown in Table 15 below.

TABLE 15

| | |
|---|---|
| Powerclass | 3 |
| RF | 2 |
| Aggregatable CC | 5 |

With reference to FIG. 15, since power class of a MS is 3, supportable RFs is 2, and aggregatable CCs is 5, the PC table of Table 12 can be specified. Here, the MS and the BS should have the PC tables of all the cases stored in the memory. When the MS informs the BS about the PCR field 2220 including various combinations of the UE power class 2210, No. of aggregatable CCs 2215, and No. of RF chain 2220, the BS can select a PC table specified by the PCR field 2200 from among all the PC tables stored in the memory and perform uplink scheduling with reference to the selected PC table.

5. Method for Transmitting Message for PCR

The MS may transmit a message for a PCR in the following case. First, immediately after an RRC connection establishment or RRC connection reestablishment is completed, (i) when the MS receives an uplink grant for transmitting new data to uplink, (ii) a message for a PCR in the form of a MAC PDU can be transmitted in uplink resource secured by an uplink grant.

Next, immediately after an RRC connection reconfiguration is completed, (i) when the MS receives an uplink grant for transmitting new data to uplink, (ii) a message for a PCR in the form of a MAC PDU can be transmitted in uplink resource secured by an uplink grant.

FIG. 23 is a flow chart illustrating a process of a method for transmitting information regarding power coordination according to an embodiment of the present invention. This shows a process of transmitting information regarding PC through a PCR field on the assumption that an RRC connection establishment or a CC establishment has been changed through an RRC connection establishment, RRC connection reestablishment, or RRC connection reconfiguration procedure.

With reference to FIG. 23, the BS transmits an uplink grant to the MS (S2300). The uplink grant may be configured as shown in Table 10. The MS generates a MAC PDU including a PCR field (S2305). The PCR field is a field for transmitting information regarding PC, which may have a structure as shown in FIGS. 21 and 22, and the MAC PDU may have a structure as shown in FIG. 20.

The MS transmits the MAC PDU to the BS by using resource allocated by the uplink grant (S2310).

The BS performs uplink scheduling with reference to the information regarding PC obtained from the PCR field (S2315).

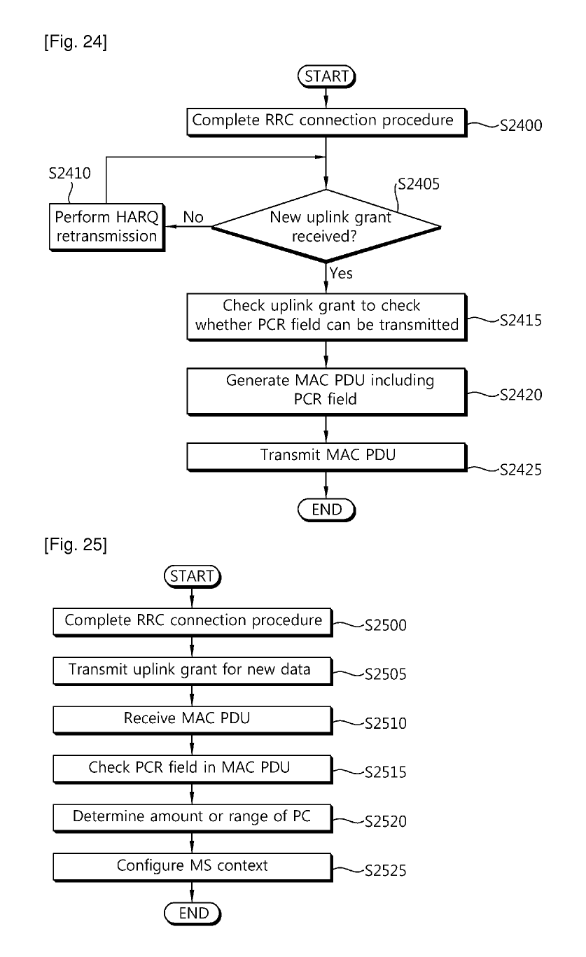

FIG. 24 is a flow chart illustrating a process of a method for transmitting information regarding power coordination by the MS according to an embodiment of the present invention.

With reference to FIG. 24, the MS completes an RRC connection procedure such as an RRC connection establishment procedure, an RRC connection reestablishment procedure, or an RRC connection reconfiguration procedure for adding/removing a CC (S2400).

After the RRC procedures are completed, the MS may receive an uplink grant from the BS. At this time, the MS determines whether or not the received uplink grant is a new uplink grant for transmission of new uplink data (S2405). Such a determination may be made through a 1-bit new data indicator (NDI) included in the uplink grant.

When the new data indicator is 0, the uplink grant is an uplink grant for retransmission of previous data, so HARQ (Hybrid Automatic Repeat reQuest) retransmission is performed (S2410). This process is performed as follows. The MS checks information to be retransmitted through information within an HARQ entity. After checking the HARQ information, the MS selects information to be retransmitted from an HARQ buffer, and retransmits the information to the BS through uplink resource based on the uplink grant.

When the new data indicator is 1, the uplink grant is a new uplink grant for transmission of new data, so the MS checks a scheduling parameter within the uplink grant and calculates an amount of resource transmittable in corresponding subframes. In this case, the MS checks whether or not a PCR field is transmittable in the corresponding subframes in consideration of the priority of data, other MAC CE data, and the information regarding PC currently stored in the uplink buffer (S2415).

When the PCR field is transmittable, the MS generates a MAC PDU including the PCR field (S2420) and transmits the generated MAC PDU to the BS by using resource allocated by the uplink grant (S2425).

FIG. 25 is a flow chart illustrating a process of a method for receiving information regarding power coordination by the BS according to an embodiment of the present invention.

With reference to FIG. 25, the BS completes an RRC connection procedure such as an RRC connection establishment procedure, an RRC connection reestablishment procedure, or an RRC connection reconfiguration procedure for adding/removing a CC (S2500). The RRC connection establishment procedure and the RRC connection reestablishment procedure may be triggered through paging.

When the RRC connection procedure is completed, the BS determines whether to configure an uplink grant for new data or whether to configure an uplink grant for retransmission according to a message requesting uplink scheduling from the MS such as a scheduling request (SR) or a buffer state report (BSR) previously received from the MS and according to whether or not previously transmitted data has an error, or the like.

In order for the MS to determine whether it is an uplink grant for transmitting new uplink data, the BS sets a new data indicator. In case of the uplink grant for transmitting new uplink data, the new data indicator is set to be 1, and in case of the uplink grant for retransmission, the new data indicator is set to be 0. Here, it is assumed that the BS transmits uplink data for new data, for the sake of brevity.

The BS transmits the uplink grant for new data to the MS (S2505). The BS receives a MAC PDU through resource allocated according to the uplink grant from the MS (S2510). At this time, the BS checks whether or not the MAC PDU includes the PCR field (S2515). To this end, the BS checks whether or not an LCKD within a subheader of the MAC indicates a PCR MAC control element based on the Table 11.

When the BS checks that the MAC PDU includes the PCR field, the BS interprets content of the PCR field, sets a PC table to be applied to the MS, and determines the amount or range of PC based on the set PC table (S2520). The BS stores the set PC table in the MS context (S2525). Thereafter, the BS performs uplink scheduling based on the determined amount or range of PC.

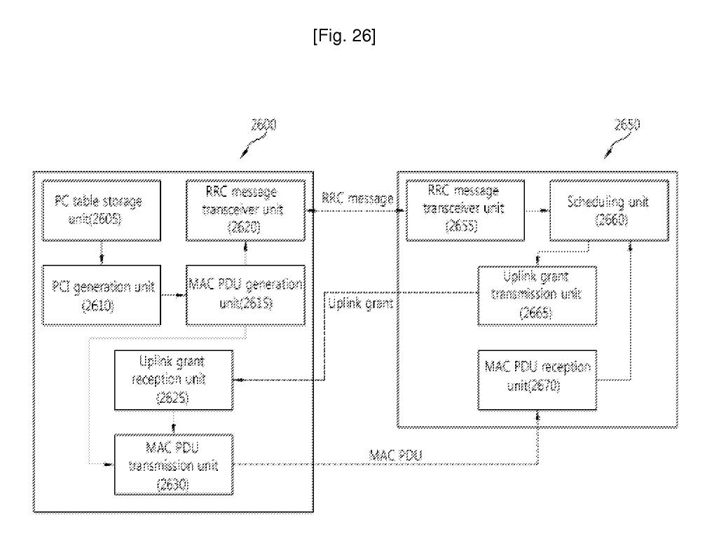

FIG. 26 is a schematic block diagram showing an apparatus for transmitting information regarding power coordination (or a PCI transmission apparatus) and an apparatus for receiving information regarding power coordination (or a PCI reception apparatus) in a multi-component carrier system according to an embodiment of the present invention.

With reference to FIG. 26, the PCI transmission apparatus 2600 includes a PC table storage unit 2605, a PCI generation unit 2610, a MAC PDU generation unit 2615, an RRC message transceiver unit 2620, an uplink grant reception unit 2625, and a MAC PDU transmission unit 2630. The PCI transmission apparatus 2600 may be part of an MS.

The PC table storage unit 2605 stores a PC table. Examples of the PC table are as shown in Table 9 or Table 12.

The PCI generation unit 2610 generates a PCR field. The PCR field indicates information regarding PC, and the information regarding PC may be a PC table index or a parameter exhibiting hardware characteristics of the MS.

The MAC PDU generation unit 2615 determines whether or not a PCR field can be inserted in a MAC PDU based on a resource situation allocated by the uplink grant, and when a PCR field can be inserted in a MAC PDU, the MAC PDU generation unit 2615 generates a MAC PDU including a PCR field.

The RRC message transceiver unit 2620 transmits various messages related to an RRC connection establishment, e.g., an RRC connection establishment message, RRC connection reestablishment message, or an RRC connection reconfiguration complete message to the PCI reception apparatus 2650 or receives an RRC connection reconfiguration message from the PCI reception apparatus 2650.

The uplink grant reception unit 2625 receives an uplink grant from the PCI reception apparatus 2650. An example of the uplink grant is as shown in Table 16 below.

TABLE 16
-Flag for format0/format1A differentiation - 1 bit, where value 0 indicates
format 0 and value 1 indicates format 1A
-Frequency hopping flag - 1 bit
-Resource block assignment and hopping resource allocation -
┌log₂(N_{RB}^{UL}(N_{RB}^{UL} + 1)/2)┐ bits
-For PUSCH hopping:

-N_{UL}_{_{—}}ₕₒₚ MSB bits are used to obtain the value of ñ_{PRB}(i)
- (┌log₂(N_{RB}^{UL}(N_{RB}^{UL} + 1)/2)┐ − N_{UL}_{_{—}}ₕₒₚ) bits provide the

resource allocation of the first slot in the UL subframe

-For non-hopping PUSCH:

- (┌log₂(N_{RB}^{UL}(N_{RB}^{UL} + 1)/2)┐) bits provide the resource

allocation in the UL subframe
-Modulation and coding scheme and redundancy version - 5 bits
-New data indicator -1 bit
-TPC command for scheduled PUSCH -2 bits
-Cyclic shift for DM RS - 3 bits
-UL index - 2 bits (this field is present only for TDD operation with
uplink-downlink configuration 0)

| | |
|---|---|
| - | Downlink Assignment Index (DAI) -2 bits (this field is present |

only for TDD operation with uplink-downlink configurations 1-6)
-CQI request -1 bit
-Carrier Index Field (CIF) -3 bits(this field is present only for Carrier
Aggregation)

The MAC PDU transmission unit 2630 transmits the MAC PDU generated by the MAC PDU generation unit to the PCI reception apparatus 2650 based on the scheduling parameter according to the received uplink grant and the information regarding PC.

The PCI reception apparatus 2650 includes an RRC message transceiver unit 2655, a scheduling unit 2660, an uplink grant transmission unit 2665, and a MAC PDU reception unit 2670. The PCI reception apparatus may be part of the BS.

The RRC message transceiver unit 2655 transmits an RRC connection reconfiguration message including CC configuration information for adding/changing a CC to the PCI transmission apparatus 2600, or receives an RRC connection reconfiguration complete message from the PCI transmission apparatus 2600.

The scheduling unit 2660 sets scheduling parameters such as MCS, TPC, or resource allocation information with respect to the PCI transmission apparatus 2600 in consideration of a channel situation, a buffer state report, a network situation, a resource usage situation, and the like, of the PCI transmission apparatus 2600. In particular, the scheduling unit 2660 sets the amount or range of PC from the information regarding PC received from the MAC PDU reception unit 2670, and performs uplink scheduling accordingly.

The uplink grant transmission unit 2665 configures an uplink grant based on the scheduling parameter determined to be valid according to results of scheduling validity determination, and transmits the configured uplink grant to the PCI transmission apparatus 2600.

The MAC PDU reception unit 2670 receives the MAC PDU including the PCR field from the PCI transmission apparatus 2600, and transmits the information regarding PC included in the PCR field to the scheduling unit 2660.

The preferred embodiments of the present invention have been described with reference to the accompanying drawings, and it will be apparent to those skilled in the art that various modifications and variations can be made in the present invention without departing from the scope of the invention. Thus, it is intended that any future modifications of the embodiments of the present invention will come within the scope of the appended claims and their equivalents.

1. A method for transmitting information regarding power coordination by a mobile station (MS) in a multi-component carrier system, the method comprising:
generating information regarding power coordination (PC) indicating an amount or a range of power which is used to adjust uplink maximum transmission power of the MS; and
transmitting the information regarding PC to a base station (BS),
wherein the information regarding PC is determined specifically by a uplink scheduling parameter for the MS, the number of component carriers set in the MS, and the number of radio frequencies (RFs) supported for the MS.

2. The method of claim 1, wherein the information regarding PC is transmitted through a radio resource control (RRC) connection establishment request message for requesting an RRC connection establishment to the BS.

3. The method of claim 1, wherein the information regarding PC is transmitted through an RRC connection reestablishment request message for reestablishing an RRC connection due to a radio link failure (RLF) between the MS and the BS.

4. The method of claim 1, wherein the uplink scheduling parameter includes a modulation and coding scheme (MCS) applied to uplink transmission of the MS and the number of resource blocks allocated to the uplink transmission of the MS.

5. A method for receiving information regarding power coordination (PC) by a base station (BS) in a multi-component carrier system, the method comprising:
receiving, from a mobile station (MS) information regarding PC indicating an amount or a range of power which is used to adjust uplink maximum transmission power of the MS;
configuring an uplink grant for the MS based on the information regarding PC;
transmitting, to the MS, the configured uplink grant; and
receiving, from the MS, uplink data generated based on the configured uplink grant and the information regarding PC.

6. The method of claim 5, wherein the information regarding PC indicates allowed amounts or ranges of PC for each of the conditions, and wherein the conditions are formed by a uplink scheduling parameter of the MS, the number of component carriers set in the MS, and the number of radio frequencies (RFs) supported for the MS.

7. (canceled)

8. A mobile station (MS) for transmitting information regarding power coordination (PC) in a multi-component carrier system, the MS comprising:
a PC table storage unit storing a mapping relationship between PC conditions and the amount or range of PC allowed for each of the PC conditions, wherein the PC conditions are formed by a uplink scheduling parameter of the MS, the number of component carriers set in MS, and the number of radio frequencies (RFs) supported for MS;
a PC information generation unit generating information regarding PC indicating the mapping relationship; and
an RRC message transceiver unit transmitting an RRC message including the information regarding PC.

9. The MS of claim 8, wherein the information regarding PC is an index indicating a table configured by the mapping relationship.

10. An apparatus for receiving information regarding power coordination (PC) in a multi-component carrier system, the apparatus comprising:
an RRC message transceiver unit receiving an RRC message including information regarding PC indicating an amount or a range of power which is used to adjust maximum transmission power of uplink transmission of a mobile station (MS);
a scheduling unit configuring an uplink scheduling parameter;
a scheduling validity determination unit determining whether or not uplink transmission based on the configured uplink scheduling parameter is made within the range of the maximum transmission power; and
an uplink grant transmission unit transmitting an uplink grant comprising the configured uplink scheduling parameter.

11. The apparatus of claim 10, wherein the information regarding PC is determined specifically by at least one of an uplink scheduling parameter, the number of component carriers, and the number of radio frequencies (RFs).

12. The apparatus of claim 11, wherein the scheduling validity determination unit determines, based on the information regarding PC, whether or not the uplink transmission based on the configured uplink scheduling parameter is made within the range of the maximum transmission power.

13. The apparatus of claim 10, wherein the information regarding PC comprises the combination of at least two among the number of aggregatable CCs of a mobile station (MS), the number of available RFs, a modulation scheme, an allocated frequency bandwidth, and the amount of resource blocks.

14.-15. (canceled)

16. A method for transmitting information regarding power coordination (PC) by a mobile station (MS) in a multi-component carrier system, the method comprising:
generating information regarding PC indicating an amount or a range of power which is used to adjust uplink maximum transmission power required for the MS;
generating a medium access control (MAC) protocol data unit (PDU) including information regarding PC; and
transmitting the MAC PDU to a base station (BS),
wherein the MAC PDU includes a MAC subheader and a power coordination report (PCR) field, the PCR field includes the information regarding PC, and the MAC subheader includes a logical channel identification (ID) (LCID) indicating the PCR field.

17. The method of claim 16, further comprising:
receiving, from the BS, an uplink grant including an uplink scheduling parameter before the MAC PDU is transmitted,
wherein the MAC PDU is transmitted based on the uplink scheduling parameter.

18. The method of claim 16, wherein the PCR field includes an index field indicating a PC table in which an amount or a range of PC is predefined for each of communication environments, wherein the communication environments are formed based on the number of component carriers (CCs) configured in the MS, the number of radio frequency (RF) chains supported for the MS, and an uplink scheduling parameter regarding the MS.

19. (canceled)

20. A method for receiving information regarding power coordination (PC) by a base station (BS), the method comprising:
transmitting, to a mobile station (MS), an uplink grant including a scheduling parameter regarding an uplink transmission of the MS; and
receiving, from the MS, a MAC PDU generated based on the scheduling parameter,
wherein the MAC PDU includes a MAC subheader and a power coordination report (PCR) field, the MAC subheader includes logical channel identification (LCID) indicating the PCR field, and the PCR field includes information regarding PC indicating an amount or a range of power which is used to adjust uplink maximum transmission power required for the MS.

21. The method of claim 20, wherein the PCR field is included in a MAC control element within the MAC PDU.

22. The method of claim 20, wherein the PCR field is included in a MAC SDU (Service Data Unit) within the MAC PDU.

23. The method of claim 20, wherein the PCR field includes an index field indicating a PC table in which an amount or a range of PC is predefined for each of communication environments, wherein the communication environments are formed based on at least one of the number of component carriers (CCs) configured in the MS, the number of radio frequency (RF) chains supported for the MS, and an uplink scheduling parameter regarding the MS.

24. (canceled)

25. An apparatus for transmitting information regarding power coordination (PC) in a multi-component carrier system, the apparatus comprising:
an uplink grant reception unit receiving an uplink grant including a scheduling parameter regarding uplink transmission;
a PC information generation unit generating information regarding PC indicating an amount or a range of power which is used to adjust uplink maximum transmission power regarding a mobile station (MS);
a MAC PDU generation unit configuring a MAC PDU including power coordination report (PCR) field based on a situation of resources allocated by the uplink grant, the PCR field including the information regarding PC; and
a MAC PDU transmission unit transmitting the MAC PDU based on the scheduling parameter regarding uplink transmission and the information regarding PC.

26.-27. (canceled)
